(19) United States
(12) Patent Application Publication
(10) Pub. No.: US 2024/0122196 A1
(43) Pub. Date: Apr. 18, 2024

(54) DAIRY ALTERNATIVE FOOD PRODUCTS

(71) Applicant: Motif Foodworks, Inc., Boston, MA (US)

(72) Inventors: Lei XU, Boston, MA (US); Hanna LONG, Dorchester, MA (US); Melissa PAGE, Cambridge, MA (US); Dilek UZUNALIOGLU, Winchester, MA (US)

(21) Appl. No.: 18/277,036

(22) PCT Filed: Feb. 14, 2022
(86) PCT No.: PCT/US2022/016345

§ 371 Date: Aug. 11, 2023

Related U.S. Application Data
(60) Provisional application No. 63/149,092, filed on Feb. 12, 2021.

(51) Int. Cl. A23C 20/00; A23C 11/06

(52) U.S. Cl. CPC A23C 20/005; A23C 11/06

(57) ABSTRACT

Disclosed are dairy alternative food compositions comprising at least one fermentation-derived casein subunit. Also disclosed are methods of producing such food compositions. Further disclosed are uses of fermentation-derived casein subunit(s) in combination with plant-based protein(s) to improve the quality of dairy alternative products.

### CROSS REFERENCE TO RELATED APPLICATIONS

This PCT application claims benefit of priority to U.S. Provisional Patent Application No. 63/149,092, filed Feb. 12, 2021, the contents of which are hereby incorporated by reference in its entirety.

### FIELD

The present disclosure generally relates to dairy alternative food products, and more specifically to use of casein subunits combined with plant-based protein(s) to make dairy alternative food products with improved taste, texture, and function.

### BACKGROUND

Bovine milk contains ˜3.0-3.5% of proteins, which are typically classified as casein and whey proteins. Casein proteins are the major proteins in milk (80%), including α-casein, αs1-casein, αs2-casein, β-casein and κ-casein. The whey proteins primarily include β-lactoglobulin (β-LG), α-lactalbumin (α-LA), bovine serum albumin (BSA), and immunoglobulins (Igs). Casein proteins are flexible phosphoproteins and co-assembled with calcium phosphate, forming large colloidal particles micellar caseins (MC) with an average diameter of ˜200 nm. There are various models of the casein micelle structure that have been proposed since the initial reports in 1969. Because of this amphiphilic nature, casein has excellent surface-active and emulsification properties. Casein and whey proteins provide different functional properties and play different roles in food formulations depending on their state and structure in an aqueous solution.

Consumer demand for dairy alternative products has increased due to the increasing awareness of sustainable food production as well as health benefit. Consumers are actively trying to eat more plant-based foods (meat or dairy alternative foods). However, plant-based dairy alternative products have certain limitations. For example, replacing dairy proteins with plant-based proteins [pea, soy, faba (fava) bean, etc.] results in a loss of aroma, taste, mouthfeel, texture, and nutritional value of conventional dairy products. This may be due to the differences in molecular structure and physical properties (e.g., molecular weight, isoelectric point, tertiary structure), manufacturing process (e.g., source of the ingredients, thermal treatment process, purification method), as well as nutritional values (e.g., amino acid composition, protein digestibility corrected amino acid scores (PDCAAS) when comparing animal proteins compared with plant proteins (McClements, et al., Comprehensive Reviews in Food Science and Food Safety, 18(6), 2047-2067; 2019).

Therefore, there is a need for plant-based dairy alternative products with a sensory profile and functional performance more closely reproducing that of animal-based dairy products.

### SUMMARY

The present disclosure describes improved dairy alternative food products prepared from casein or casein subunit(s) combined with plant-based protein(s). The disclosed food products include, but are not limited to, cheese, yogurt, milk, ready-to-drink (RTD) beverages, cheese sauce, ice cream and refrigerated or frozen desserts, snack bars, confectioneries, and dry blend powders for a variety of food uses. The disclosed food products exhibit improved qualities relative to other dairy food substitutes, in that they provide a creamier texture, smoother mouthfeel, and exhibit other sensory properties and functional performance more closely approximating those of animal-based dairy products.

In various aspects, the disclosed dairy alternative food products comprise at least one casein subunit, which may be created using fermentation processes; multiple casein subunits may be used and may comprise one or more casein or casein subunit proteins derived from microbial fermentation. A casein subunit may be or may comprise any one or more of α-casein, αs1-casein, αs2-casein, β-casein, κ-casein, para-κ-casein or any combination thereof. In various aspects, at least one casein subunit may comprise one or more casein subunits that is free from or substantially free from one of the other subunits, for example comprising α-casein, κ-casein (and/or para-κ-casein), and/or a combination thereof, free, or substantially free of β-casein; alternatively, the casein subunit(s) may comprise α-casein, β-casein, and/or a combination thereof, free of κ-casein or para-κ-casein.

Accordingly, in one aspect the present disclosure provides a dairy alternative cheese analog composition comprising about 0.1% to about 25% by weight of at least one casein subunit, about 1% to about 28% by weight of at least one plant protein, at least one fat, and at least one stabilizer component.

In some aspects, a casein subunit comprises α-casein, αs1-casein, αs2-casein, β-casein, κ-casein, para-κ-casein or any combination thereof.

In some aspects, at least one plant protein comprises one or more proteins derived from cereals, pseudo-cereals, legumes, pulses, nuts, or flours thereof, and/or a combination thereof.

In some aspects, at least one fat comprises at least one non-dairy fat in an amount of about 15% to about 40% by weight of the composition.

In some aspects, at least one stabilizer component comprises at least one starch, at least one gum (such as pectin), and/or any combination thereof.

In some aspects, any of the dairy alternative cheese analog compositions disclosed herein may further comprise at least one organic or inorganic acid.

In some aspects, any of the dairy alternative cheese analog compositions disclosed herein may further comprise at least one emulsifying salt.

In some aspects, any of the dairy alternative cheese analog compositions disclosed herein may further comprise at least one antimicrobial component.

For any of the dairy alternative cheese analog compositions disclosed herein, improved stretchability, meltability and/or mouthfeel are positively impacted compared to a plant-based dairy-free cheese product not comprising at least one casein subunit.

In some aspects, the dairy alternative cheese analog compositions disclosed herein may comprise about 0.3% to about 2% by weight of α-casein subunit. In some aspects, these compositions may further comprise about 0.3% to about 2% by weight of β-casein subunit. Still in some aspects, these compositions may further comprise about 0.3% to about 2% by weight of κ-casein subunit.

In another aspect, the present disclosure provides a dairy alternative yogurt analog composition. Such composition comprises about 0.1% to about 25% by weight of at least one protein derived using microbial fermentation such as at least one casein subunit, about 1% to about 28% by weight of at least one plant protein, at least one fat, at least one stabilizer component, and a yogurt culture.

For any of the dairy alternative yogurt analog compositions disclosed herein, in some aspects, the at least one casein subunit comprises α-casein, αs1-casein, αs2-casein, β-casein, κ-casein, para-κ-casein or any combination thereof.

In some aspects, at least one plant protein comprises one or more proteins derived from cereals, pseudo-cereals, legumes, pulses, nuts, or flours thereof, and/or a combination thereof.

In some aspects, the at least one fat comprises at least one plant-based fat in an amount of about 1% to about 20% by weight of the composition.

In some aspects, the at least one stabilizer component comprises at least one starch, at least one gum (such as pectin), and/or any combination thereof.

In some aspects, any of the dairy alternative yogurt analog compositions disclosed herein may further comprise at least one organic or inorganic acid.

In some aspects, any of the dairy alternative yogurt analog compositions disclosed herein may further comprise at least one emulsifying salt.

In some aspects, any of the dairy alternative yogurt analog compositions disclosed herein may further comprise at least one sugar and/or sweetener.

In some aspects, any of the dairy alternative yogurt analog compositions disclosed herein may further comprise at least one antimicrobial component.

For any of the dairy alternative yogurt analog compositions disclosed herein, it has an improved mouthfeel compared to a plant-based yogurt not comprising at least one casein subunit.

In another aspect, the present disclosure provides a dairy alternative food composition. Such composition comprises at least about 0.1% to about 25% by weight of at least one casein subunit (derived from microbial fermentation), at least about 1% to about 28% by weight of at least one plant protein; at least one fat; at least one stabilizer component; and at least one sugar and/or sweetener.

For any of the dairy alternative food compositions disclosed herein, in some aspects, at least one plant protein comprises one or more proteins derived from cereals, pseudo-cereals, legumes, pulses, nuts, or flours thereof, and/or a combination thereof.

In some aspects, the dairy alternative food composition further comprises at least one flavoring component and/or nutritional additive.

In some aspects, the food composition is a dairy alternative milk formulation, and the at least one stabilizer component comprises at least one alginate, at least one gelatin, at least one starch, at least one gum, at least one pectin, and/or any combination thereof.

In some aspects, the food composition is a dairy alternative milk formulation, and the at least one fat comprises soybean oil, corn oil, coconut oil, canola oil, sunflower oil, coconut cream, palm oil, avocado oil, coconut butter, olive oil, hazelnut oil, sesame oil, walnut oil, almond oil, cocoa butter, grapeseed oil, hemp oil, safflower seed oil, vegetable oil, high oleic fatty acid oil, and/or any combination thereof.

In some aspects, the food composition is a dairy alternative ice cream, ice milk, or sherbet formulation, and the at least one stabilizer component comprises at least one alginate, at least one gelatin, at least one starch, at least one gum, at least one pectin, and/or a combination thereof.

In some aspects, the food composition is a dairy alternative ice cream or ice milk formulation, and at least one fat comprises soybean oil, corn oil, coconut oil, canola oil, sunflower oil, coconut cream, palm oil, avocado oil, coconut butter, olive oil, hazelnut oil, sesame oil, walnut oil, almond oil, cocoa butter, grapeseed oil, hemp oil, safflower seed oil, vegetable oil, high oleic fatty acid oil, and/or any combination thereof.

In some aspects, the food composition is a ready-to-drink beverage.

In some aspects, the food composition is a frozen dessert.

In some aspects, the food composition is a cheese sauce.

In some aspects, the food composition is a snack bar.

In some aspects, the food composition is a dry blend powder.

In some aspects, the food composition is a confectionery.

In some aspects, any of the dairy alternative food compositions disclosed herein may further comprise water and/or a plant-based milk in an amount providing the balance of the composition by weight.

In another aspect, the present disclosure provides a method of producing a dairy alternative food composition. Such method comprises adding about 1% to about 25% by weight of at least one casein subunit (protein) derived from microbial fermentation to a plant-based food matrix.

In another aspect, the present disclosure provides use of at least one fermentation derived casein subunit in combination with at least one plant protein to produce a dairy alterative food composition.

Other aspects and features of the disclosure are detailed below.

### BRIEF DESCRIPTION OF THE DRAWINGS

FIG. 1 is a schematic of natural cheese, a plant-based cheese analog, and a plant-based cheese analog comprising casein.

FIG. 2 shows images of different plant-based cheese analog samples (top) and yogurt analog samples (bottom) each comprising different amounts of casein and pea proteins.

FIG. 3 is a schematic showing matrix interaction among casein and/or casein subunits, plant protein, fat, starch, minerals, and water in dairy alternative food products.

FIGS. 4A-4B show effects of casein added to a pea protein-based Mozzarella-type cheese analog on the gel strength/hardness of the cheese. FIG. 4A is a bar graph comparing the hardness or springiness of different pea-based Mozzarella-type cheese analog samples: with 4% pea protein, no casein added [control (bar 1)], 3% pea protein with 1% casein added (bar 2), and 2% pea protein with 2% micellar casein added (bar 3). FIG. 4B shows images of different cheese analog samples comprising different amounts of casein and pea proteins.

FIGS. 5A-5B show effects of casein added to pea protein-based Cheddar-type cheese analog on the gel strength/hardness of the cheese. FIG. 5A is a bar graph comparing the hardness or springiness of different pea-based Cheddar-type cheese analog samples: 4% pea protein, no casein added [control (bar 1)], 3% pea protein with 1% casein added (bar 2), and 2% pea protein with 2% micellar casein added (bar 3). FIG. 5B shows images of different Cheddar-type cheese analog samples comprising different amounts of casein and pea proteins.

FIGS. 6A-6B show effects of various casein factions/subunits added to plant-based Mozzarella-type cheese analog products on the gel strength/hardness of the cheese. FIG. 6A is a bar graph comparing the hardness or springiness of different plant-based Mozzarella-type cheese analog samples: α-casein added (bar 2), β-casein added (bar 3), and κ-casein added (bar 4). FIG. 6B shows images of different cheese analog samples comprising different types of casein fractions/subunits.

FIG. 7 shows images of different Mozzarella-type cheese analog samples comprising different types of casein subunits.

FIGS. 8A-8B show effects of various caseins added to plant-based Mozzarella-type cheese analog products on the gel strength/hardness of the cheese. FIG. 8A is a bar graph comparing the hardness or springiness of different plant-based mozzarella analog samples: micellar casein added (bar 1), casein+rennet added (bar 2), and rennet casein added (bar 3).

FIG. 8B shows images of different cheese analog samples comprising different types of casein proteins.

FIG. 9 shows images of different mozzarella-type cheese analog samples comprising different types of casein proteins.

FIG. 10 shows impact of pea proteins from three different suppliers on cheese analog products, where 80% and 85% indicate total protein content (dry basis).

FIG. 11 shows impact of pea proteins from different suppliers on cheese analog products.

FIG. 12 shows images of different Mozzarella-type cheese analog samples comprising different amount of soy protein and casein.

FIG. 13 shows results of baking test performed on different experimental plant-based cheese analog products including casein, compared to a consumer brand real dairy cheddar cheese product and three consumer brand plant-based dairy-free cheese analog products.

FIG. 14 shows images of different pea protein containing yogurt analog samples with or without casein added.

FIG. 15 shows images of pea protein containing yogurt analog samples with or without casein and casein subunits added.

FIG. 16 shows images of cheese sauce analog sample with casein or casein subunits added.

FIG. 17 shows qualitative results of oven melt tests performed on real mozzarella, real sharp cheddar, and a commercially available, consumer brand vegan block cheese, to provide controls.

FIG. 18 shows qualitative results of oven melt test performed on various plant-based cheese analog products containing single, double, or triple casein subunits, compared to a control cheese analog containing 0% casein.

FIG. 19 is a bar graph providing quantitative results of an oven melt test performed on various plant-based cheese analog products containing single, double, or triple casein subunits, compared to a control cheese analog containing 0% casein and a market-available real cheese and plant-based cheese analog product.

FIG. 20 shows qualitative results of oven stretch tests performed on real mozzarella, real sharp cheddar, and the commercially available, consumer brand vegan block cheese, to provide controls.

FIG. 21 shows qualitative results of oven stretch test performed on various plant-based cheese analog products containing single, double, or triple casein subunits, compared to a control cheese analog containing 0% casein.

FIG. 22 is a bar graph providing quantitative results of oven melt tests performed on various plant-based cheese analog products containing single, double, or triple casein subunits, compared to a control cheese analog containing 0% casein and a market-available real cheese product and plant-based cheese analog product.

FIG. 23 shows qualitative results of microwave melt tests performed on real mozzarella, real sharp cheddar, and the commercially available, consumer brand vegan block cheese, to provide controls.

FIG. 24 shows qualitative results of microwave melt tests performed on various plant-based cheese analog products containing single, double, or triple casein subunits, compared to a control cheese containing 0% casein.

FIG. 25 is a bar graph providing quantitative results of microwave melt tests performed on various plant-based cheese analog products containing single, double, or triple casein subunits, compared to a control cheese analog containing 0% casein and a market-available real cheese product and plant-based cheese analog product.

FIG. 26 shows qualitative results of microwave stretch tests performed on real mozzarella, real sharp cheddar, and the commercially available, consumer brand vegan block cheese, to provide controls.

FIG. 27 shows qualitative results of microwave stretch tests performed on various plant-based cheese analog products containing single, double, or triple casein subunits, compared to a control cheese analog containing 0% casein.

FIG. 28 is a bar graph providing quantitative results of microwave melt tests performed on various plant-based cheese analog products containing single, double, or triple casein subunits, compared to a control cheese analog containing 0% casein and a market-available real cheese product and a plant-based cheese analog product.

### DETAILED DESCRIPTION

The disclosed methods and compositions may be understood more readily by reference to the following detailed description of various aspects and the Examples included therein and to the Figures and the previous and following descriptions.

It is to be understood that the disclosed methods and compositions are not limited to specific synthetic methods, specific analytical techniques, or to particular reagents unless otherwise specified, and, as such, may vary. It is also to be understood that the terminology used herein is for the purpose of describing particular aspects only and is not intended to be limiting.

The present disclosure provides dairy alternative food products with a sensory profile (e.g., appearance, taste, texture, and mouthfeel) and functional performance more closely approximating those of real (i.e., animal milk-based) dairy products. In particular, the present disclosure describes the use of casein subunit(s) in combination with plant-based protein(s) to improve the quality of dairy alternative food products, including, but not limited to, cheese, cheese sauce, yogurt, milk, ready to drink (RTD) beverages, frozen desserts, snack bars, confectioneries and dry blended powders. These dairy alternative products have improved qualities in that they possess an improved milky, creamy, and smooth sensory profile more closely reproducing the sensory properties and functional performance of animal-based dairy products. For example, the dairy alternative products are improved with respect to meltability and stretchability as compared to other dairy alternative cheeses, and improved with respect to the blistered and browned color, appearance and extended shelf-life as compared to other dairy alternative products such as yogurts, dairy beverages, and frozen dairy desserts. Additionally, the present disclosure describes how the selection of, and/or selective combination of casein subunits can impact the qualities and functional performance of dairy alternative food products. Still further, the present disclosure describes the use of casein subunit(s) which are not derived directly from animal milk, but rather are produced using microbial fermentation wherein casein subunit(s)-specific DNA sequences are inserted into microbes to express target casein subunit proteins within the cell, or are secreted into a fermentation broth. It will be appreciated that microbial engineering methods for producing casein subunits are highly amenable to process optimization such that the protein production process is much more efficient than the dairy industry. In contrast to traditional dairy production which requires breeding and maintaining vast numbers of stock animals, fermentation approaches to casein subunit production avoids substantial emission of greenhouse gases and uses far less land and water resources.

Section headings as used in this section and the entire disclosure herein are merely for organizational purposes and are not intended to be limiting.

### Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting. As used herein, the following terms have the meanings ascribed to them unless specified otherwise.

When introducing elements of the present disclosure or the preferred aspects(s) thereof, the articles “a”, “an”, “the” and “said” are intended to mean that there are one or more of the elements. The terms “comprising”, “including” and “having” are intended to be inclusive and mean that there may be additional elements other than the listed elements.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

As used herein, the terms “optional” or “optionally” mean that the subsequently described event or circumstance may or may not occur, and that the description includes instances where said event or circumstance occurs and instances where it does not.

As used interchangeably herein, the terms “casein subunit” and “casein fraction” refer to α-casein, αs1-casein, αs2-casein, β-casein, κ-casein or para-κ-casein.

As used interchangeably herein, the terms “casein subunits” and “casein fractions” refer to two or more of α-casein, αs1-casein, αs2-casein, β-casein, κ-casein and para-κ-casein.

As used herein, the term “fermentation-derived casein subunits,” refers to casein subunits produced by biological techniques in which casein subunit(s)-specific DNA sequences are inserted into microbes to express target proteins such as α-casein, αs1-casein, αs2-casein, β-casein, and κ-casein after feeding on a sugary substrate. The term “fermented-derived casein subunits” refers to casein subunits produced by a microbial system such as a yeast system in which the casein subunit(s) are secreted into a fermentation broth or are produced intracellularly and cells lysed after fermentation.

As used herein, the term “casein” or “casein protein” refers to any one of a family of related phosphoproteins commonly found in mammalian milk, comprising a combination of casein subunits in a micelle, and encompasses rennet casein and micellar casein. The term “micellar casein” and the term “casein” are used interchangeably, although micellar casein usually refers to the purest form of casein. In milk, casein congregates as micelles, essentially solid particles floating in liquid.

As used herein, the term “rennet casein” refers to a phosphorus-protein complex (micelles) resulting from milk treatment with chymosin or pepsin. The micellar structure and the presence of calcium give rennet casein its texturizing properties.

As used herein, the term “caseinate” refers to a stable salt of casein such as sodium caseinate, which is derived from casein and is chemically extracted from skim milk.

As used herein, the term “sensory profile” refers to a range of characteristics related to sensation or physical senses and transmitted or perceived by the senses. For example, sensory profile includes how creamy, smooth, grainy or astringent a dairy alternative product is.

As used herein, “cheese meltability” is defined as the ease and extent at which cheese flows upon heating.

As used herein, “cheese stretchability” is defined as the ability of the cheese to stretch when melted. Stretch refers to the capacity of melted cheese to form fibrous strands that extend under tension.

As used herein, “texture” refers to a rating of a food product according to its firmness: soft, semi-soft, semi-hard, or hard. It is a physical property of the food product such as crumbly, crunchy, creamy, etc.

As used herein, “mouthfeel” refers to the way a food product feels in one's mouth, e.g., creamy, smooth, rough, sticky, etc.

As used herein, the term “shredability” refers to a property of cheese normally assessed visually after the cheese is shredded. This property seems to be directly related to the length of the shreds produced, indirectly related to the number of fragments present, and to the stickiness among the shreds.

As used herein, a “yogurt culture” refers to a carefully balanced blend of bacteria that consume lactose. The mixture of bacteria converts the lactose in milk to lactic acid, giving yogurt a classic, deliciously tangy taste, A standard yogurt culture comprises Lactobacillus delbrueckii subsp. bulgaricus and Streptococcus thermophilus bacteria. Optionally, other lactobacilli and bifidobacteria can be added during or after culturing yogurt.

As used herein, “syneresis in yogurt” refers to the shrinkage of gel, and this occurs concomitantly with expulsion of liquid or whey separation and is related to instability of the gel network resulting in the loss of the ability to entrap all the serum phase.

### I. Dairy Alternative Cheese Analog Compositions

The present disclosure provides a dairy alternative cheese analog composition. Such composition comprises about 0.1% to about 25% by weight of at least one casein subunit, about 1% to about 28% by weight of at least one plant protein, at least one fat, and at least one stabilizer component. The casein subunit or subunits may be derived by microbial fermentation.

Traditional cheese is a dairy product derived from milk of cows, buffalo, goats, or sheep. It is produced by coagulation of casein and comprises animal proteins and fats. In contrast, the cheese analog disclosed herein is a non-dairy product that comprises casein and/or casein subunit(s), plant protein(s), and non-dairy fat, in which the casein subunit(s) may be derived from microbial fermentation.

For any of the dairy alternative cheese analog compositions disclosed herein, the at least one casein subunit may be or may comprise any one or more of α-casein, αs1-casein, αs2-casein, β-casein, κ-casein, para-κ-casein and/or any combination thereof.

In some aspects, the dairy alternative cheese analog compositions disclosed herein may comprise about 0.3% to about 2% by weight of α-casein subunit. In some aspects, these compositions may further comprise about 0.3% to about 2% by weight of β-casein subunit. Still in some aspects, these compositions may further comprise about 0.3% to about 2% by weight of κ-casein subunit.

For any of the dairy alternative cheese analog compositions disclosed herein, the at least one plant protein comprises one or more proteins derived from cereals, pseudo-cereals, legumes, pulses, nuts, or flours thereof, and/or a combination thereof. By way of non-limiting example, the plant protein can be derived from oat, rice, corn, quinoa, wheat, buckwheat, soy, pea, faba (fava) bean, canola (rapeseed), lupin, lentil, chickpea, peanuts, almond, cashew, macadamia, hazelnut, walnut, mushrooms, mushroom mycelium, duckweed, rapeseed (canola), and/or algae. Non-limiting but exemplary compositions include one or more of pea, soy, and/or bean protein.

For any of the dairy alternative cheese analog compositions disclosed herein, the at least one fat comprises at least one non-dairy fat in an amount of about 15% to about 40% by weight of the composition. By way of non-limiting example, a dairy alternative soft cheese analog composition may contain up to 40% of fat, while a dairy alternative hard cheese analog composition may contain from about 15% to about 25% of fat. Suitable non-dairy fats include, but are not limited to, soybean oil, corn oil, coconut oil, canola oil, sunflower oil, coconut cream, palm oil, avocado oil, coconut butter, olive oil, hazelnut oil, sesame oil, walnut oil, almond oil, cocoa butter, grapeseed oil, hemp oil, safflower seed oil, vegetable oil, high oleic fatty acid oil, and/or any combination thereof. By way of non-limiting example, a dairy alternative cheese analog composition disclosed herein comprises coconut oil, sunflower oil, canola oil, vegetable oil, high oleic fatty acid oil, and/or any combination thereof.

For any of the dairy alternative cheese analog compositions disclosed herein, the at least one stabilizer component comprises at least one starch, at least one gum, at least one pectin, and/or a combination thereof. Suitable starch includes, but is not limited to, potato starch, corn starch, tapioca starch, rice starch, plantain starch, and/or any combination thereof. By way of non-limiting example, a dairy alternative cheese analog composition disclosed herein comprises potato starch, corn starch, tapioca starch, and/or any combination thereof.

Suitable gums include, but are not limited to, xanthan gum, locus bean gum, guar gum, agar, konjac gum, gum acacia, gum arabic, and/or any combination thereof. By way of non-limiting example, a dairy alternative cheese analog composition disclosed herein comprises xanthan gum, locus bean gum, and/or any combination thereof. Some gums are natural emulsifiers, as they contain both hydrophilic and hydrophobic portions that can stabilize and keep the lipid phase dispersed evenly throughout the water phase, while other gums contribute similar functionality by stabilizing the formulation.

Optionally, any of the dairy alternative cheese analog compositions disclosed herein may further comprise at least one organic or inorganic acid, such as but not limited to, citric acid, lactic acid, malic acid, tartaric acid, phosphoric acid, and/or any combination thereof. By way of non-limiting example, a dairy alternative cheese analog composition disclosed herein comprises citric acid, lactic acid, and/or a combination thereof.

Acidification of the cheese analog compositions disclosed herein can and should be comparable to acidification of dairy cheese as known in the art, to avoid problems such as lack of flavor, susceptibility to contamination, poor meltability, etc. As such, dairy alternative cheese analog compositions as described herein may include a food acid such as citric acid, vinegar, lemon juice or tartaric acid. By way of non-limiting example, in making a dairy alternative, Mozzarella-type cheese analog composition, the addition of citric acid also creates the ideal environment for rennet, which causes the casein to coagulate.

Optionally, any of the dairy alternative cheese analog compositions disclosed herein may further comprise at least one emulsifying salt, which adds stability to the cheese by sequestering divalent cations through more efficient emulsification. Suitable salts include, but are not limited to, sodium citrate, trisodium citrate, tetrasodium pyrophosphate, sodium tripolyphosphate, sodium hexametaphosphate, disodium orthophosphate, and/or any combination thereof.

Some soft cheese analogs can be made without a salt or a salt substitute, but hard cheese analogs and mold-ripened cheese analogs require a salt or a salt substitute. A salt or a salt substitute is used not only for flavor, but also to control bacteria that grow inside the cheese, help with texture development, regulate moisture, and help preserve the cheese as it ages.

Optionally, any of the dairy alternative cheese analog compositions disclosed herein may further comprise at least one antimicrobial component suitable for human consumption, such as a GRAS antimicrobial component. By way of non-limiting example, an antimicrobial component may be or comprise nisin or Lactobacillus microorganisms. Potassium sorbate may function as an anti-mold agent.

The dairy alternative cheese analog compositions disclosed herein exhibit improved stretchability, meltability and/or mouthfeel compared to a plant-based dairy-free cheese analog product not comprising at least one casein subunit. Stretchability of cheese analogs can be measured by methods known in the art, among which the most common method used by cheese manufacturers and pizza companies is the Fork Test first marketed by the U.S. Department of Agriculture in 1980. In this test, grated cheese is placed on a pizza crust containing pizza sauce; after the pizza is baked, a fork is inserted into the melted cheese and raised vertically until all the cheese strands break. The length of the strands at the break point is used as a measure of stretchability of cheese. The Fork Test is useful for internal comparisons performed by a single person or a group following the same testing procedure and standards, but since it is performed differently by different people as to where and how the fork is inserted, tine orientation, the amount of tine covered by the cheese, and the speed used to lift the cheese, it can make cross-study comparisons challenging.

A more objective stretchability test was developed by adapting a texture-profile analyzer to pull strands of cheese upwards from a reservoir of melted cheese (Fife, et al., Journal of Dairy Science, 85(12): 3539-3545, 2002). In this test, cheese is placed in a stainless-steel cup and tempered in a water bath at 60, 70, 80, or 90° C. for 30 min. The cup is then placed in a water-jacketed holder mounted on the base of the analyzer. A three-pronged hook-shaped probe is lowered into the melted cheese and then pulled vertically until all cheese strands break or 30 cm is reached, thus producing a stretch profile. To characterize the stretchability of the cheese, three parameters are defined: (1) the maximum load, obtained as the probe is lifted through the cheese, is defined as melt strength (F_{M}); (2) the distance to which cheese strands are lifted is defined as stretch length (SL); and (3) the load exerted on the probe as the strands of cheese are being stretched is defined as stretch quality (SQ). Although this test was developed for testing the stretchability of dairy cheese, the test may be used to test the stretchability of plant cheese.

Meltability can be measured by methods known in the art, among which the Schreiber Test is the most widely used in the industry (Kosikowski, Cheese and Fermented Milk Foods, 2^{nd} ed., p. 337-340, 1977). The Schreiber Test in its original form involves a cylindrical cheese specimen (41 mm in diameter, 4.8 mm in height) centered on a concentrically numbered target-type graph. The specimen is heated in an oven set to 232° C. for 5 min; the longest flow line from the center to the edge of the melt is then measured as cheese meltability. Various known modifications to the Schreiber Test can be used. For example, covered and uncovered Schreiber Tests for cheese meltability have been described (Altan, et al., Journal of Dairy Science, 88(3): 857-861, 2005), in which the tests are performed on glass Petri dishes, with and without covers placed over the samples, at 100, 150, and 232° C. Meltability of different samples is determined based on the melt spread distance and area. At 232° C., the covered Schreiber Test is considered superior to the uncovered test.

Textural properties of cheese analogs can be measured by various tests. For example, several tests are available to measure firmness and hardness of cheese such as using a grating rig, a wire cutter or knife blade, fracture wedges, grating by hand, etc. When using a grating rig, the movement of the arm provides the necessary pulling action to grate the cheese analog. The forces to do so are measured imitating the ease of difficulty one would experience when grating cheese analogs. A simple cutting test measures the force required to cut through the cheese analog, indicating the firmness and consistency of a cheese analog. Fracture wedges measures the firmness, hardness and brittleness of a cheese analog by quantifying “force to fracture” measurements.

To study mouthfeel, analytical methods such as food rheology, food tribology, and psychorheology can be used. Food rheology analyzes how cheese flows and deforms under certain stresses and conditions. In some embodiments, the rheological behavior of dairy alternative cheese analogs includes linear viscoelastic behavior, power-law stress relaxation, firmness, springiness, rubberiness, and strain at the departure from linear viscoelasticity (i.e., strain-to-break) may be similar to that of dairy cheese. Food tribology studies the friction, wear and lubrication of cheese as it is processed in the mouth. Psychorheology analyzes the sensual perception of cheese. In addition, sensory methods such as temporal dominance of sensation (TDS) can also be used to study mouthfeel. TDS studies the sequence of dominant sensations of cheese during its consumption. That is, TDS methods can be used to measure and describe the dominant sensations as they vary over a time period in which a subject is consuming the cheese.

Any of the dairy alternative cheese analog compositions disclosed herein may further comprise water in an amount providing the balance of the composition by weight.

### II. Dairy Alternative Yogurt Analog Compositions

The present disclosure also provides a dairy alternative yogurt analog composition. Such composition comprises about 0.1% to about 25% by weight of at least one casein subunit derived using microbial fermentation, about 1% to about 28% by weight of at least one plant protein, at least one fat, at least one stabilizer component, and a yogurt culture. In another embodiment, the dairy alternative yogurt analog composition comprises about 0.1% to about 10% by weight of at least one casein subunit derived using microbial fermentation, about 1% to about 10% by weight of at least one plant protein, at least one fat, at least one stabilizer component, and a yogurt culture.

Traditional yogurt is unstrained and normally made from dairy ingredients and fermented in the cups or tubs with or without sugar or sweeteners. Traditional yogurt comprises animal proteins and fats. In contrast, the yogurt analog disclosed herein is a non-dairy product that comprises fermentation-derived casein and casein subunit(s), plant protein(s), and non-dairy fat.

For any of the dairy alternative yogurt analog compositions disclosed herein, a casein subunit may comprise α-casein, αs1-casein, αs2-casein, β-casein, κ-casein, para-K-casein and/or any combination thereof.

For any of the dairy alternative yogurt analog compositions disclosed herein, the at least one plant protein may comprise one or more proteins derived from cereals, pseudo-cereals, legumes, pulses, nuts, or flours thereof, and/or a combination thereof. By way of a non-limiting example, the plant protein can be derived from oat, rice, corn, quinoa, wheat, buckwheat, soy, pea, faba (fava) bean, lupin, lentil, chickpea, peanuts, almond, cashew, macadamia, hazelnut, walnut, mushrooms, mushroom mycelium, duckweed, rapeseed (canola), or algae, or flours thereof. Pea, soy, and/or bean protein are the most commonly used plant-based proteins in dairy alternative yogurt analog products.

For any of the dairy alternative yogurt analog compositions disclosed herein, the at least one fat may comprise at least one plant-based fat in an amount of about 1% to about 20% by weight of the composition. By way of a non-limiting example, the dairy alternative yogurt analog composition disclosed herein comprises from about 1% to about 10% of fat content. Still by way of a non-limiting example, the dairy alternative yogurt analog composition disclosed herein comprises from about 1% to about 6%, or from about 2% to about 5% of fat content. Suitable plant-based fats include, but are not limited to, soybean oil, corn oil, coconut oil, canola oil, sunflower oil, coconut cream, palm oil, avocado oil, coconut butter, olive oil, hazelnut oil, sesame oil, walnut oil, almond oil, cocoa butter, grapeseed oil, hemp oil, safflower seed oil, vegetable oil, high oleic fatty acid oil, and/or a combination thereof. By way of non-limiting example, a dairy alternative yogurt analog composition disclosed herein comprises coconut oil, sunflower oil, canola oil, vegetable oil, high oleic fatty acid oil, and/or a combination thereof.

In any of the dairy alternative yogurt analog compositions disclosed herein, the at least one stabilizer component may comprise at least one alginate, at least one gelatin, at least one starch, at least one gum, at least one pectin, and/or any combination thereof. Suitable alginate includes, but is not limited to, sodium alginate, which is an algae extract used as a food stabilizer. Gelatin is a protein-based stabilizer to enable the thickened milk-like product to keep the density and viscosity consistent throughout the production batch. In traditional yogurt, gelatin is of porcine (pork) or beef origin. Alternatively, a vegetarian equivalent gelatin may be used. By way of non-limiting example, any carrageenan may be used as a stabilizer in the dairy alternative yogurt analog products disclosed herein.

Any of the dairy alternative yogurt analog compositions disclosed herein may comprise at least one starch including, but not limited to potato starch, corn starch, tapioca starch, rice starch, plantain starch, and/or a combination thereof. By way of non-limiting example, a dairy alternative yogurt analog composition disclosed herein comprises rice starch, corn starch, tapioca starch, potato starch, plantain starch, and/or a combination thereof.

Any of the dairy alternative yogurt analog compositions disclosed herein may comprise at least one gum including, but not limited to xanthan gum, locus bean gum, guar gum, agar, konjac gum, gum acacia, gum arabic, and/or a combination thereof. By way of non-limiting example, a dairy alternative yogurt analog composition disclosed herein may comprise xanthan gum, locus bean gum, and/or any combination thereof. Some gums are natural emulsifiers, as they contain both hydrophilic and hydrophobic portions that stabilize and keep the lipid phase evenly dispersed throughout the water phase, while other gums contribute similar functionality by stabilizing the formulation.

Any of the dairy alternative yogurt analog compositions disclosed herein comprise a yogurt culture, which is a blend of bacteria that consume sugar(s) as known in the art. The blend of bacteria converts available sugar(s) to lactic acid and generates polysaccharide, giving yogurt a recognizable, delicious, tangy taste. Any known yogurt culture can be used, including but not limited to Lactobacillus delbrueckii subsp. bulgaricus, and Streptococcus thermophilus bacteria. In addition, other lactobacilli and bifidobacteria may be added during or after culturing yogurt. Commercially available yogurt cultures suitable for dairy alternative yogurt analog compositions as disclosed herein include, but are not limited to, YOFLEX by Chr. Hansen, Greek Yogurt Starter Culture or Cultures for Health Vegan Yogurt Starter Culture made by Cultures for Health®, Freeze-Dried Yogurt Starter made by Yogurtmet®, Yogurt Starter Culture (Creamy) made by New England Cheese Making Supply Co., and other commercial brands.

Optionally, any of the dairy alternative yogurt analog compositions disclosed herein may further comprise at least one organic or inorganic acid including, but not limited to, citric acid, lactic acid, malic acid, tartaric acid, phosphoric acid, and/or any combination thereof. By way of non-limiting example, a dairy alternative yogurt analog composition disclosed herein comprises citric acid, lactic acid, and/or a combination thereof. Lactic acid is the main organic acid found in all yogurts. The acidity of yogurt is usually set between pH 4.0 and 4.6 in which fermentation is arrested by rapid cooling. The amount of lactic acid present at this pH level is ideal for yogurt, giving it the characteristic tartness, aiding in thickening, and acting as a preservative against undesirable microbes.

Optionally, any of the dairy alternative yogurt analog compositions disclosed herein may further comprise at least one emulsifying salt, which adds stability to yogurt by sequestering divalent cations through more efficient emulsification. Suitable salts include, but are not limited to, sodium citrate, trisodium citrate, tetrasodium pyrophosphate, sodium tripolyphosphate, sodium hexametaphosphate, disodium orthophosphate, and/or any combination thereof.

Optionally, any of the dairy alternative yogurt analog compositions disclosed herein may further comprise at least one sugar or sweetener including, but not limited to, a monosaccharide, a disaccharide, and/or any combination thereof. By way of non-limiting example, a dairy alternative yogurt analog compositions disclosed herein may comprise glucose, fructose, maltose, and/or a combination thereof. Still by way of non-limiting example, a dairy alternative yogurt analog compositions disclosed herein may comprise a non-caloric sugar and/or sweetener, an artificial sugar and/or sweetener, a natural sugar and/or sweetener, a plant-based sugar and/or sweetener, and/or a combination thereof.

For any of the dairy alternative yogurt analog compositions disclosed herein, the at least one sugar and/or sweetener may be at a concentration of about 1% to about 12%, from about 3% to about 8%, or from about 4% to about 7% by weight of the composition. By way of non-limiting example, the at least one sugar and/or sweetener is at a concentration of about 6% by weight of the composition.

Optionally, any of the dairy alternative yogurt analog compositions disclosed herein may further comprise at least one antimicrobial component suitable for human consumption, such as a GRAS antimicrobial component. By way of non-limiting example, an antimicrobial component may be or comprise nisin or Lactobacillus microorganisms. Potassium sorbate may function as an anti-mold agent.

The dairy alternative yogurt analog compositions disclosed herein exhibit improved mouthfeel compared to a plant-based yogurt analog composition not comprising at least one casein subunit. To study mouthfeel, analytical methods such as food rheology, food tribology, and psychorheology can be used. In particular, food rheology analyzes how cheese flows and deforms under certain stresses and conditions. Food tribology studies the friction, wear, and lubrication of cheese as it is processed in the mouth. Psychorheology is used to establish textural quality of foods, e.g., how food “feels” in the mouth, capturing the “sense” of food as it is consumed. In addition, sensory methods such as temporal dominance of sensation (TDS) can also be used to study mouthfeel. TDS studies the sequence of dominant sensations of yogurt during its consumption. That is, the dominant sensations vary over time.

For any of the dairy alternative yogurt analog compositions disclosed herein, it may further comprise water in an amount providing the balance of the composition by weight.

### III. Additional Dairy Alternative Food Compositions

The present disclosure further contemplates other dairy alternative food compositions such as, but not limited to, a ready-to-drink beverage, a refrigerated or frozen dessert, and a cheese sauce. Such compositions can comprise at least about 0.1% to about 25% by weight of at least one casein subunit, at least about 1% to about 28% by weight of at least one plant protein, at least one fat; at least one stabilizer component; and at least one sugar and/or sweetener. In another embodiment, the dairy alternative food compositions comprise at least about 0.1% to about 10% by weight of at least one casein subunit, at least about 1% to about 10% by weight of at least one plant protein, at least one fat; at least one stabilizer component; and at least one sugar and/or sweetener.

For any of the dairy alternative food compositions disclosed herein, the at least one casein subunit comprises α-casein, αs1-casein, αs2-casein, β-casein, κ-casein, para-κ-casein or any combination thereof, and the at least one plant protein comprises one or more proteins derived from cereals, pseudo-cereals, legumes, pulses, nuts, or flours thereof, and/or a combination thereof. By way of non-limiting example, the plant protein can be derived from oat, rice, corn, quinoa, wheat, buckwheat, soy, pea, fava, bean, lupin, lentil, chickpea, peanuts, almond, cashew, macadamia, hazelnut, walnut, mushrooms, mushroom mycelium, duckweed, rapeseed (canola), or algae. Pea, soy, or bean protein are the most commonly used plant-based proteins in dairy alternative food products.

Dairy alternative food compositions disclosed herein may further comprise at least one flavoring component and/or nutritional additive. A flavoring component can be a natural flavoring substance, an artificial flavoring agent, or a nature-identical flavoring agent. By way of non-limiting example, a flavoring component can be selected from any GRAS food substances, such as 2,3-Butanedione (diacetyl) CH₃COCOCH₃, 3-(Methylthio)propanal (methional) CH₃SCH₂CH₂CHO, 4-Hydroxy-2,5-Dimethyl-33(2H)furanone (furaneol), 2-Methylpyrazine, 2-Acetyl-1-pyrroline, 2-Acetyl-1,4,5,6-tetrahydropyridine, Trimethyl oxazole H₃C, 2-Acetylthiophene, Bis(2-Methyl-3-furyl) disulfide, 2-Acetylthiazole, 3-Methyl-5-pentyl-1,2,4-trithiolane, 3-Methylbutanal, 3-Methylbutanol, Methanethiol, Dimethyl sulphide (DMS), 2-Methylpropanol, Dimethyl trisulphied (DMTS), Triethyl citrate, Isovaleric acid, Propionic acid, Butyric acid, Butanone, Hexanal, Pentanal, 1-Octen-3-one, γ-Undecalactone, and γ-Decalactone. Also by way of non-limiting example, a nutritional additive can be selected from any GRAS additives, such as calcium, vitamin A, vitamin D, vitamin C (ascorbic acid), vitamin B₁ (thiamine), vitamin B₂ (riboflavin), vitamin B₃ (niacin), vitamin B₅ (pantothenic acid), vitamin B₆ (pyridoxine), vitamin B₁₂ (cobalamin), vitamin B₉ (folic acid) and β-carotene.

A dairy alternative food composition disclosed herein may be a dairy alternative milk formulation, in which the at least one stabilizer component comprises at least one alginate, at least one gelatin, at least one starch, at least one gum, at least one pectin, and/or a combination thereof. A suitable alginate includes, but is not limited to, sodium alginate, which is an algal extract used as a food stabilizer. Gelatin is a protein-based stabilizer to enable a thickened milk product to keep the density and viscosity consistent throughout the production batch. Suitable gums include, but are not limited to, xanthan gum, locus bean gum, guar gum, agar, konjac gum, gum acacia, gum arabic, and/or a combination thereof. Suitable starches include, but are not limited to, potato starch, corn starch, tapioca starch, rice starch, plantain starch, and/or a combination thereof. By way of a non-limiting example, a dairy alternative yogurt analog composition disclosed herein may comprise xanthan gum, locus bean gum, and/or a combination thereof. Some gums are natural emulsifiers, as they contain both hydrophilic and hydrophobic portions that have the ability to stabilize and keep the lipid phase dispersed evenly throughout the water phase, while other gums contribute similar functionality by stabilizing the formulation.

For the dairy alternative milk formulation disclosed herein, the at least one fat comprises soybean oil, corn oil, coconut oil, canola oil, sunflower oil, coconut cream, palm oil, avocado oil, coconut butter, olive oil, hazelnut oil, sesame oil, walnut oil, almond oil, cocoa butter, grapeseed oil, hemp oil, safflower seed oil, vegetable oil, high oleic fatty acid oil, and/or any combination thereof. By way of non-limiting example, a dairy alternative milk formulation disclosed herein comprises coconut oil, sunflower oil, vegetable oil, high oleic fatty acid oil, and/or a combination thereof.

A dairy alternative food composition may be a dairy alternative ice cream or ice milk-like formulation, in which the at least one stabilizer component comprises at least one alginate, at least one gelatin, at least one starch, at least one gum, at least one pectin, and/or any combination thereof. The at least one gum and/or at least one starch can also be used as an emulsifier(s). By way of non-limiting example, lecithin can be added to the dairy alternative food composition as an emulsifier. Lecithin may be derived from legumes such as soybeans, kidney beans, and black beans, or from a non-soy source such as sunflowers and corns. In any dairy alternative ice cream or ice milk-like formulation disclosed herein, the at least one fat may comprise soybean oil, corn oil, coconut oil, canola oil, sunflower oil, coconut cream, palm oil, avocado oil, coconut butter, olive oil, hazelnut oil, sesame oil, walnut oil, almond oil, cocoa butter, grapeseed oil, hemp oil, safflower seed oil, vegetable oil, high oleic fatty acid oil, and/or any combination thereof.

Optionally, any of the dairy alternative food compositions disclosed herein may further comprise water and/or a plant-based milk in an amount providing the balance of the composition by weight. By way of non-limiting example, the plant-based milk is coconut milk, almond milk, oat milk, soy milk, cashew milk, barley milk, rice milk, or a combination thereof.

The present disclosure further provides a method of producing a dairy alternative food composition and the dairy alternative food composition so produced. Such method comprises adding about 0.1% to about 25% by weight of at least one fermentation-derived casein subunit to a plant-based food matrix.

To prepare any of the dairy alternative food compositions disclosed herein, one or more casein subunits are first fermentation derived. In particular, casein subunit(s)-specific DNA sequences were inserted into microbes to express target proteins such as α-casein, αs1-casein, αs2-casein, β-casein, and/or κ-casein after feeding on a sugary substrate. Alternatively, casein subunits were produced by fermenting milk products such as plain dairy yogurt, cheese, etc.

Next, the casein subunits were added to a plant-based food matrix and mixed with plant-based oil, starch, gum, and optionally salt, citric acid, flavoring and/or nutritional agent(s). A plant-based food matrix comprises plant cell matrices and fibrous tissues and can be viewed as a physical domain that contains and/or interacts with specific constituents of food providing properties that are different from those exhibited by the components in isolation or a free state. The food matrix interacted with the casein subunit(s) thereby producing dairy alternative food products that possess improved properties compared to dairy alternative food products that do not comprise the casein subunit(s).

Moreover, the present disclosure provides use of at least one fermentation-derived casein subunit in combination with at least one plant protein to produce a dairy alterative food composition.

As various changes could be made in the above-described compositions and methods without departing from the scope of the invention, it is intended that all matter contained in the above description and in the examples given below, shall be interpreted as illustrative and not in a limiting sense.

### IV. EXEMPLARY EMBODIMENTS

Embodiment 1: A dairy alternative cheese-like composition, comprising:
(a) about 0.1% to about 25% by weight of at least one casein subunit;
(b) about 1% to about 28% by weight of at least one plant protein;
(c) at least one non-dairy fat; and
(d) at least one stabilizer component.

Embodiment 2: The dairy alternative cheese analog composition of embodiment 1, wherein the at least one casein subunit comprises α-casein, αs1-casein, αs2-casein, β-casein, κ-casein, para-κ-casein or a combination thereof.

Embodiment 3: The dairy alternative cheese analog composition of any preceding embodiment, wherein the at least one non-dairy fat is in an amount of about 15% to about 40% by weight of the composition.

Embodiment 4: The dairy alternative cheese analog composition of embodiment 3, wherein the at least one non-dairy fat comprises soybean oil, corn oil, coconut oil, canola oil, sunflower oil, coconut cream, palm oil, avocado oil, coconut butter, olive oil, hazelnut oil, sesame oil, walnut oil, almond oil, cocoa butter, grapeseed oil, hemp oil, safflower seed oil, vegetable oil, high oleic fatty acid oil, and/or a combination thereof.

Embodiment 5: The dairy alternative cheese analog composition of any preceding embodiment, wherein the at least one stabilizer component comprises at least one starch, at least one gum, at least one pectin, and/or a combination thereof.

Embodiment 6: The dairy alternative cheese analog composition of embodiment 5, wherein the at least one starch is selected from the group consisting of potato starch, corn starch, tapioca starch, rice starch, plantain starch, and/or a combination thereof, and wherein the at least one gum is selected from the group consisting of xanthan gum, locus bean gum, guar gum, agar, konjac gum, gum acacia, gum arabic and a combination thereof.

Embodiment 7: The dairy alternative cheese analog composition of any preceding embodiment, further comprising at least one organic or inorganic acid, and/or at least one emulsifying salt.

Embodiment 8: The dairy alternative cheese analog composition of embodiment 7, wherein the at least one organic or inorganic acid comprises citric acid, lactic acid, malic acid, tartaric acid, a phosphoric acid, and/or a combination thereof, and wherein the at least one emulsifying salt is selected from the group consisting of sodium citrate, trisodium citrate, tetrasodium pyrophosphate, sodium tripolyphosphate, sodium hexametaphosphate, disodium orthophosphate, and/or a combination thereof.

Embodiment 9: The dairy alternative cheese analog composition of any preceding embodiment, wherein the composition has improved stretchability, meltability and/or mouthfeel compared to a plant-based dairy-free cheese analog product not comprising casein or at least one casein subunit.

Embodiment 10: The dairy alternative cheese analog composition of any preceding embodiment, wherein the composition comprises about 0.3% to about 2% by weight of α-casein.

Embodiment 11: The dairy alternative cheese analog composition of embodiment 10, further comprising about 0.3% to about 2% by weight of β-casein.

Embodiment 12: The dairy alternative cheese analog composition of embodiment 11, further comprising about 0.3% to about 2% by weight of κ-casein.

Embodiment 13: The dairy alternative cheese analog composition of any preceding embodiment, further comprising at least one plant protein.

Embodiment 14: The dairy alternative cheese analog composition of embodiment 13, wherein the at least one plant protein comprises one or more proteins derived from oat, rice, corn, quinoa, wheat, buckwheat, soy, pea, faba (fava) bean, canola (rapeseed), lupin, lentil, chickpea, peanuts, almond, cashew, macadamia, hazelnut, walnut, mushrooms, mushroom mycelium, duckweed, rapeseed (canola), and/or algae.

Embodiment 15: A dairy alternative yogurt analog composition, comprising:
(a) about 0.1% to about 25% by weight of at least one casein subunit;
(b) about 1% to about 28% by weight of at least one plant protein;
(c) at least one non-dairy fat;
(d) at least one stabilizer component; and
(e) a yogurt culture.

Embodiment 16: The dairy alternative yogurt analog composition of embodiment 15, wherein the at least one casein subunit comprises α-casein, αs1-casein, αs2-casein, β-casein, κ-casein, para-κ-casein and/or a combination thereof.

Embodiment 17: The dairy alternative yogurt analog composition of embodiment 15 or 16, wherein the at least one non-dairy fat comprises at least one plant-based fat in an amount of about 1% to about 20% by weight of the composition.

Embodiment 18: The dairy alternative yogurt analog composition of embodiment 17, wherein the at least one non-dairy fat comprises soybean oil, corn oil, coconut oil, canola oil, sunflower oil, coconut cream, palm oil, avocado oil, coconut butter, olive oil, hazelnut oil, sesame oil, walnut oil, almond oil, cocoa butter, grapeseed oil, hemp oil, safflower seed oil, vegetable oil, high oleic fatty acid oil, and/or a combination thereof.

Embodiment 19: The dairy alternative yogurt analog composition of any one of embodiments 15 to 18, wherein the at least one stabilizer component comprises at least one alginate, at least one gelatin, at least one starch, at least one gum, at least one pectin, at least one emulsifying salt, and/or a combination thereof.

Embodiment 20: The dairy alternative yogurt analog composition of embodiment 19, wherein the at least one gum is selected from the group consisting of xanthan gum, locus bean gum, guar gum, agar, konjac gum, gum acacia, and/or a combination thereof, and wherein the at least one starch is selected from the group consisting of potato starch, corn starch, tapioca starch, rice starch, plantain starch, and/or a combination thereof.

Embodiment 21: The dairy alternative yogurt analog composition of any one of embodiments 15 to 20, further comprising at least one organic and/or inorganic acid, at least one emulsifying salt, and/or at least one sugar and/or sweetener.

Embodiment 22: The dairy alternative yogurt analog composition of embodiment 21, wherein at least one organic or inorganic acid comprises citric acid, lactic acid, malic acid, tartaric acid, a phosphoric acid, and/or a combination thereof.

Embodiment 23: The dairy alternative yogurt analog composition of embodiment 21, wherein the at least one emulsifying salt is selected from the group consisting of sodium citrate, trisodium citrate, tetrasodium pyrophosphate, sodium tripolyphosphate, sodium hexametaphosphate, disodium orthophosphate, and/or a combination thereof.

Embodiment 24: The dairy alternative yogurt analog composition of embodiment 21, wherein the at least one sugar or sweetener comprises a monosaccharide, a disaccharide, and/or a combination thereof.

Embodiment 25: The dairy alternative yogurt analog composition of embodiment 21, wherein the at least one sugar and/or sweetener comprises a non-caloric sugar and/or sweetener, an artificial sugar and/or sweetener, a natural sugar and/or sweetener, a plant-based sugar and/or sweetener, and/or a combination thereof.

Embodiment 26: The dairy alternative yogurt analog composition of embodiment 24 or 25, wherein the at least one sugar or sweetener is at a concentration of about 1% to about 12%, from about 3% to about 8%, or from about 4% to about 7% by weight of the composition.

Embodiment 27: The dairy alternative yogurt analog composition of embodiment 26, wherein the at least one sugar or sweetener is at a concentration of about 6% by weight of the composition.

Embodiment 28: The dairy alternative yogurt analog composition of any one of embodiments 15 to 27, wherein the yogurt has improved mouthfeel compared to a plant-based yogurt not comprising at least one casein subunit.

Embodiment 29: The dairy alternative cheese- or yogurt analog composition of any preceding embodiment, wherein the at least one plant protein comprises one or more proteins derived from cereals, pseudo-cereals, legumes, pulses, nuts, or flours thereof, and/or a combination thereof.

Embodiment 30: The dairy alternative cheese- or yogurt analog composition of any preceding embodiment, further comprising at least one antimicrobial component.

Embodiment 31: The dairy alternative cheese or yogurt analog composition of embodiment 30, wherein the at least one antimicrobial component comprises nisin, Lactobacillus microorganisms, or potassium sorbate.

Embodiment 32: The dairy alternative yogurt analog composition of any preceding embodiment, further comprising at least one plant protein.

Embodiment 33: The dairy alternative yogurt analog composition of embodiment 32, wherein the at least one plant protein comprises one or more proteins derived from oat, rice, corn, quinoa, wheat, buckwheat, soy, pea, faba (fava) bean, canola (rapeseed), lupin, lentil, chickpea, peanuts, almond, cashew, macadamia, hazelnut, walnut, mushrooms, mushroom mycelium, duckweed, rapeseed (canola), and/or algae.

Embodiment 34: A dairy alternative food composition, comprising:
(a) about 0.1% to about 25% by weight of at least one casein subunit;
(b) about 1% to about 28% by weight of at least one plant protein;
(c) at least one plant-based or non-animal fat;
(d) at least one stabilizer component; and
(e) at least one sugar and/or sweetener.

Embodiment 35: The dairy alternative food composition of embodiment 34, wherein the at least one plant protein comprises one or more proteins derived from cereals, pseudo-cereals, legumes, pulses, nuts, or flours thereof, and/or a combination thereof.

Embodiment 36: The dairy alternative food composition of embodiment 35, wherein the plant protein comprises one or more proteins derived from oat, rice, corn, quinoa, wheat, buckwheat, soy, pea, fava, bean, lupin, lentil, chickpea, peanuts, almond, cashew, macadamia, hazelnut, walnut, mushrooms, mushroom mycelium, duckweed, rapeseed (canola), and/or algae.

Embodiment 37: The dairy alternative food composition of any one of embodiments 34 to 36, further comprising at least one flavoring component and/or nutritional additive.

Embodiment 38: The dairy alternative food composition of embodiment 37, wherein the nutritional additive is calcium, vitamin D, and/or a combination thereof.

Embodiment 39: The dairy alternative food composition of embodiment 34, wherein the at least one stabilizer component comprises at least one alginate, at least one gelatin, at least one starch, at least one gum, at least one pectin, and/or a combination thereof.

Embodiment 40: The dairy alternative food composition of embodiment 39, wherein the at least one gum is selected from the group consisting of xanthan gum, locus bean gum, guar gum, agar, konjac gum, gum acacia, and/or a combination thereof, and wherein the at least one starch is selected from the group consisting of potato starch, corn starch, tapioca starch, rice starch, plantain starch, and/or a combination thereof.

Embodiment 41: The dairy alternative food composition of embodiment 34, wherein the at least one plant-based or non-animal fat comprises soybean oil, corn oil, coconut oil, canola oil, sunflower oil, coconut cream, palm oil, avocado oil, coconut butter, olive oil, hazelnut oil, sesame oil, walnut oil, almond oil, cocoa butter, grapeseed oil, hemp oil, safflower seed oil, vegetable oil, high oleic fatty acid oil, and/or a combination thereof.

Embodiment 42: The dairy alternative food composition of any one of embodiments 34 to 41, wherein the food composition is a dairy alternative milk formulation, a dairy alternative ice cream- or ice milk-like formulation, a ready-to-drink beverage, a frozen dessert, a cheese sauce, a dry blended powder, a snack bar-type food, or a confectionery.

Embodiment 43: The dairy alternative food composition of any one of embodiments 34 to 42, further comprising water and/or a plant-based milk in an amount providing the balance of the composition by weight.

Embodiment 44: The dairy alternative food composition of embodiment 43, wherein the plant-based milk is selected from the group consisting of coconut milk, almond milk, oat milk, soy milk, cashew milk, barley milk, rice milk, and/or a combination thereof.

Embodiment 45: A method of producing a dairy alternative food composition, comprising adding about 0.1% to about 25% by weight of at least one casein subunit to a plant-based food matrix.

Embodiment 46: A dairy alternative food composition produced by the method of embodiment 41.

Embodiment 47: Use of at least one casein subunit in combination with at least one plant protein to produce a dairy alterative food composition.

### V. EXAMPLES

### Example 1: Effects of Casein Fractions/Subunits on Pea-Based Cheese

Commercial real dairy cheese and/or pea-based samples were analyzed for their formulations, cooking functionalities and sensory profiles. Dairy alternative cheese analog products containing plant-based protein ingredients such as, but not limited to pea, vegetable oils such as, but not limited to, soy, corn, and/or sunflower, commercially available gums and starches such as, but not limited to guar gum, pectin, potato and rice starches, GRAS ingredients such as, bot limited to, stabilizers, salts, flavor compounds and water.

Pea-based cheese analogs was were noted as beany, grainy and astringent, wherein pea proteins aggregated and demonstrated poor solubility. Pea-based cheese analogs also exhibited poor stretchability.

When casein subunits αs1-casein, αs2-casein, and/or κ-casein were added to the pea-based cheese analog matrix, the resultant alternative cheese analog products demonstrated the following characteristics, in comparison to pea-based cheese analogs not containing casein: (1) improved meltability and stretchability; (2) improved creamy and smooth mouthfeel; (3) reduced hardness; and (4) higher whiteness color index.

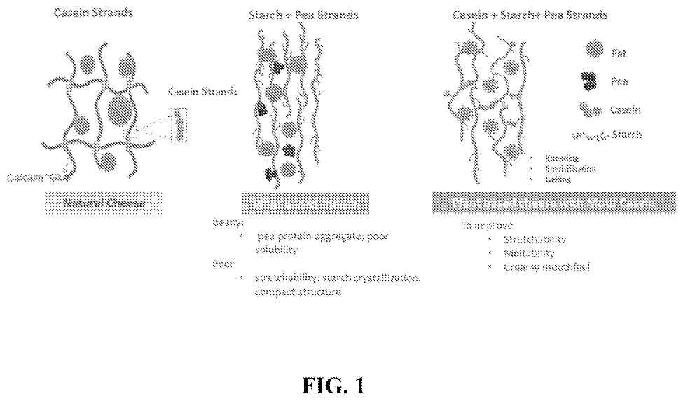

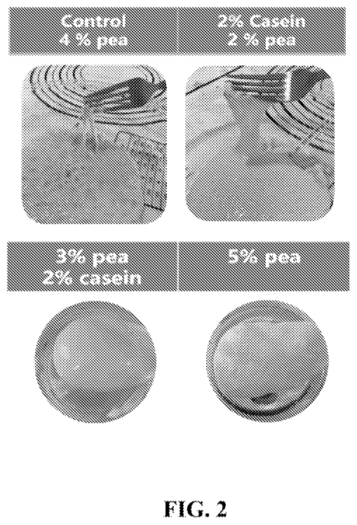

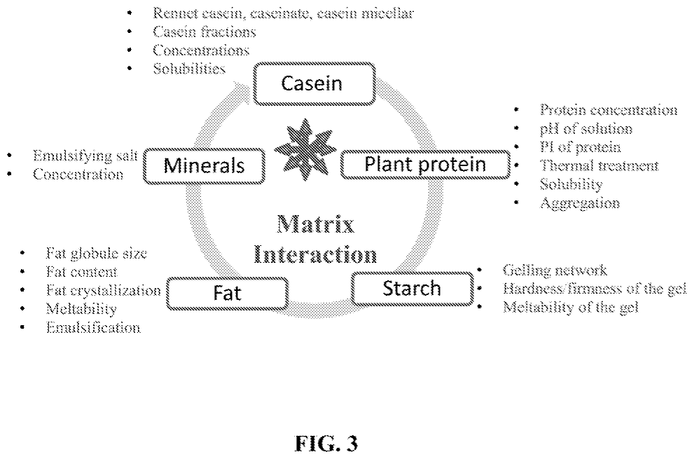

A schematic view of natural cheese, pea-based cheese analogs (without casein), and pea-based cheese analogs including casein subunits is shown in FIG. 1. Images of different cheese analog samples comprising different amounts of casein and pea protein are shown in FIG. 2. Matrix interaction among casein and/or casein subunits, plant proteins, fats, starches and minerals is shown in FIG. 3.

### Example 2: Dairy Alternative Cheese with Casein Subunits

A blend of fermentation-derived casein subunits (a blend of αs1-casein and αs2-casein, β-casein, κ-casein, and para-κ-casein), pea proteins, coconut oil, starch, gum, salt, acid, and flavor agent(s) were combined to form a cheese analog matrix. Various amounts of casein subunits and pea proteins were evaluated, e.g., 0.5%, 1%, or 2% of casein subunits, and 0%, 1%, 2%, 3%, 4%, 5%, or 6% of pea proteins were mixed with coconut oil, along with potato starch, corn starch, xanthan gum, salt, and citric acid. Mozzarella-type and cheddar-type cheese analog products were formulated. Table 1 below shows an exemplary Mozzarella-like formulation.

TABLE 1
Mozzarella-type Cheese Formula

| | | | |
|---|---|---|---|
| Water | 43-46% | Casein Subunits | 2.00% |
| Coconut Fat | 20-25% | Salt | 1.80% |
| Potato Starch | 10-12% | Flavor | 0.50% |
| Tapioca Starch | 8-10% | Citric Acid | 0.50%0.10% |
| Corn Starch | 1-2% | | |
| Pea Protein | 2.00% | | |
| Gum | 0.20% | | |

Each cheese product was tested for its cooking functionality (pizza), including shredability, meltability, stretchability, and burn tests. Methods known in the art can be used for such tests, and in this example were conducted as follows:

The shredability of Mozzarella-type cheese was studied by sensory, instrumental and chemical means. An image analysis system was used to measure accurately the physical characteristics of the shreds and values were assigned that correlate well with the ability of the cheese to shred. Gel strength and yield stress of the mixture were evaluated by a Rheometer using small strain amplitude oscillatory testing method. The apparent viscosity of Mozzarella-type cheese upon melting was analyzed 1 week after manufacturing in a 4800 Rapid Visco Analyser (Perten Instruments, Australia). 25 g of each sample was grated and placed into a disposable aluminum canister with polycarbonate paddle. Each sample was then subjected to a temperature profile from 25° C. to 90° C. for more than 5 min, held at 90° C. for 3 min, and cooled to 40° C. for more than 5 min, with constant shear of 300 rpm. The apparent hot melt viscosity corresponding to the minimum viscosity of the cheese during this cycle was taken in triplicate for each sample, and the minimum hot melt viscosity reported in cP.

To measure meltability, the gold standard Schreiber Test was used, wherein the increase (%) in diameter of a 50 g cheese disc was measured upon heating.

Stretchability of samples was measured by the Pull Factor/Fork Test or by a Texture Analyzer. For Pull Factor test, a fork was dipped into the center of the sample and extended vertically, while simultaneously evaluating stringiness and stretchiness of the cheese. Alternatively, a Texture Analyzer was used to pull an extensibility rig through molten cheese, allowing the extensibility and resistance to extension to be measured.

The Burn Test involves browning of the cheese using a baking test, followed by a visual inspection and/or colorimeter measurement. 50 grams of cheese was placed on a baking pan in the oven at 400° F. for 5 mins.

The cheese analog products were also evaluated for sensory profiles. Optionally, samples could be sent to a professionally trained sensory panel team (a third party) that would perform a formal sensory test to evaluate the results, with individual panelist responses and statistically collected data.

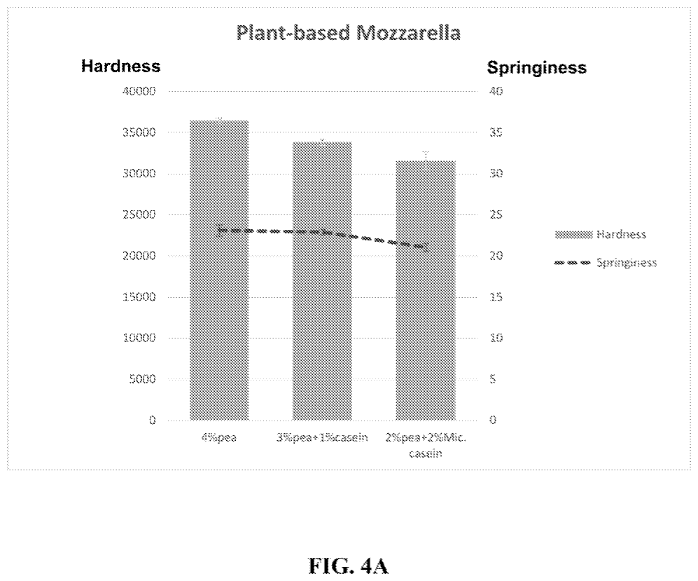

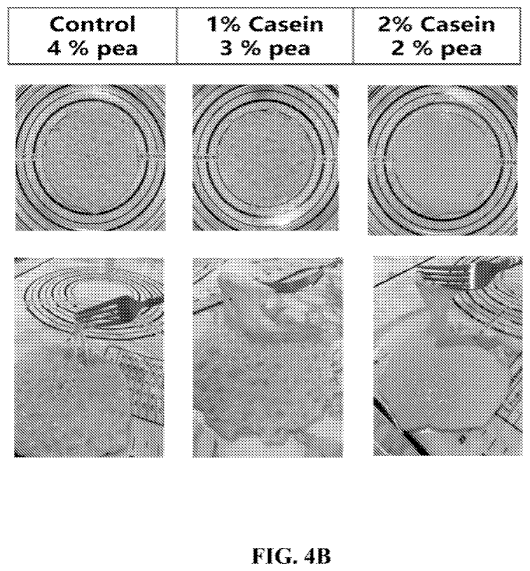

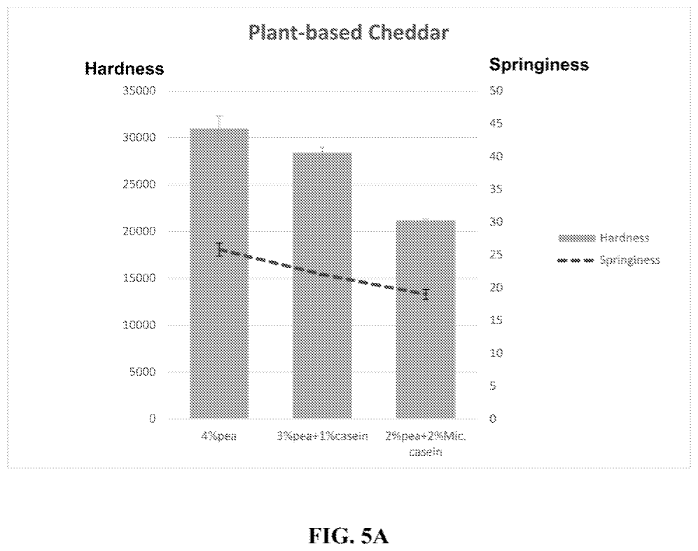

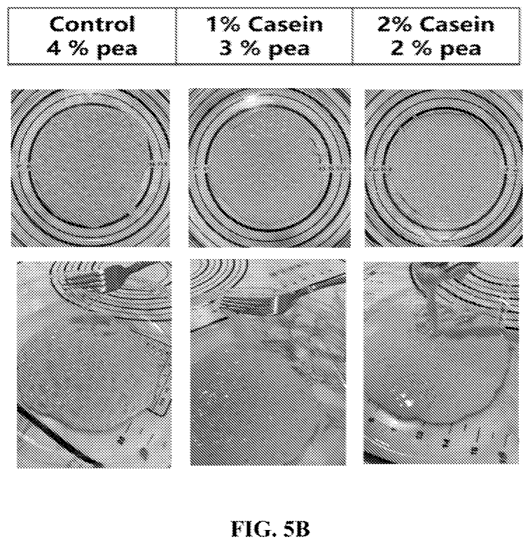

The addition of casein and casein subunit into plant-based cheese analogs surprisingly improved meltability and stretchability, improved creaminess and provided a smoother mouthfeel, and reduced hardness of both Mozzarella-type (FIGS. 4A-4B) and cheddar cheese analog products (FIGS. 5A-5B). Different plant-based Mozzarella or cheddar-like samples were evaluated: 4% pea protein, no casein added [control (bar 1 in FIG. 4A and FIG. 5A)], 3% pea protein with 1% casein added (bar 2 in FIG. 4A and FIG. 5A), and 2% pea protein with 2% micellar casein added (bar 3 in FIG. 4A and FIG. 5A). FIG. 4B and FIG. 5B show the actual appearances of the three different Mozzarella-type or cheddar-cheese type cheese analog samples.

### Example 3: Different Casein Subunits in Plant-Based Cheese

Different casein subunits (α-casein, β-casein, and κ-casein) obtained from Sigma-Aldrich Co., of various purity levels, were added to a pea-based Mozzarella-like matrix to produce various cheese analog products, which were then evaluated for cooking functionalities as described in Example 2 above. Each cheese analog product contained 2% pea protein and 2% casein subunits (α-casein, β-casein, and κ-casein).

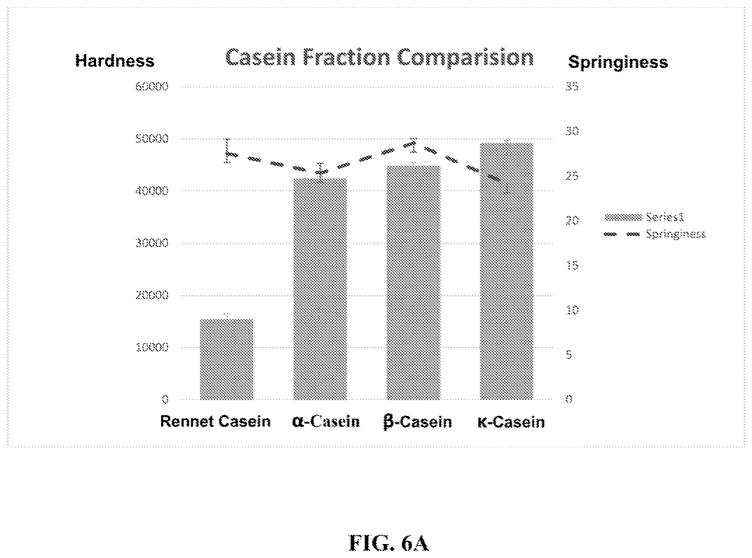

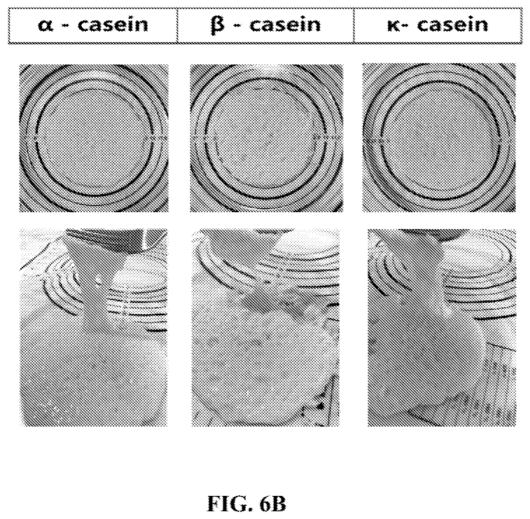

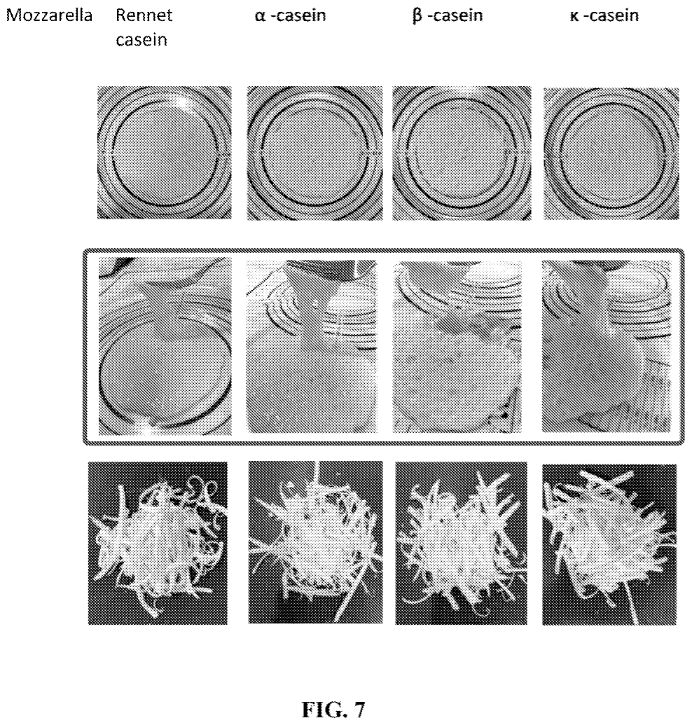

The results of the effects of different casein subunits on the gel strength/hardness of the Mozzarella-like cheese analog products are show in FIG. 6A-6B. Casein subunits increased the gel strength/hardness of the cheese analog products (FIG. 6A). Preliminary results indicated that the Mozzarella-like mixture made with α-casein or κ-casein provided a significant improvement in meltability and stretchability than a cheese analog made with β-casein (FIG. 6B and FIG. 7).

### Example 4: Effects of Different Casein Proteins on Plant-Based Cheese

Different casein proteins (micellar casein, casein+rennet, rennet casein, and casein) were added to a pea-based Mozzarella-like matrix to produce various cheese analog products, which were then evaluated for cooking functionalities as described in Example 2 above. Each product contained 2% pea protein and 2% casein.

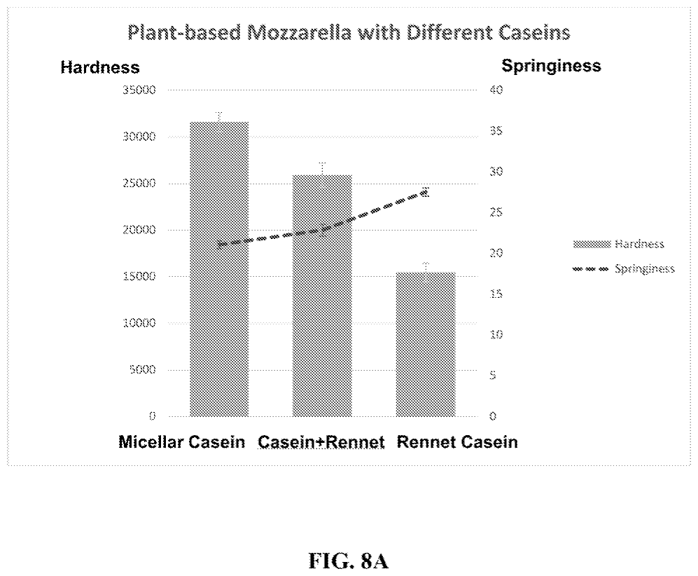

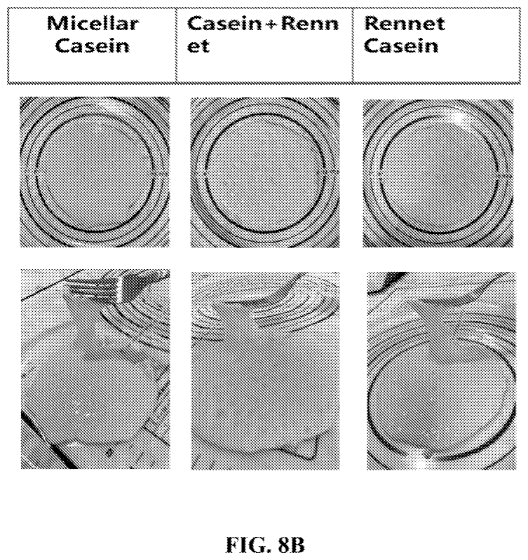

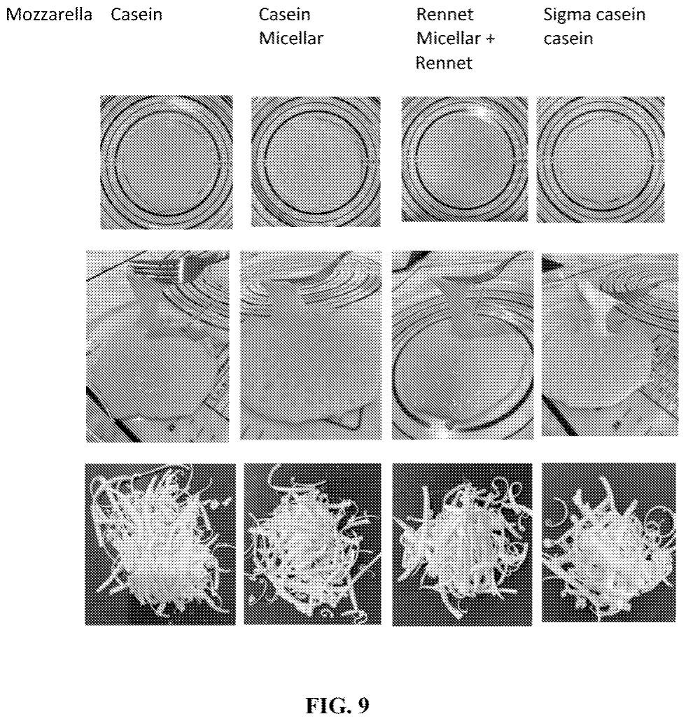

The effects of different casein proteins on the gel strength/hardness of the Mozzarella-like products are show in FIG. 8A-8B. Rennet casein decreased the gel strength/hardness (FIG. 8A); and cheese analog formulations made with rennet casein provided the best stretchability among the various casein types (FIG. 8B and FIG. 9), while the meltability was similar among the various casein types.

### Example 5: Effects of Different Pea Protein Sources on Plant-Based Cheese

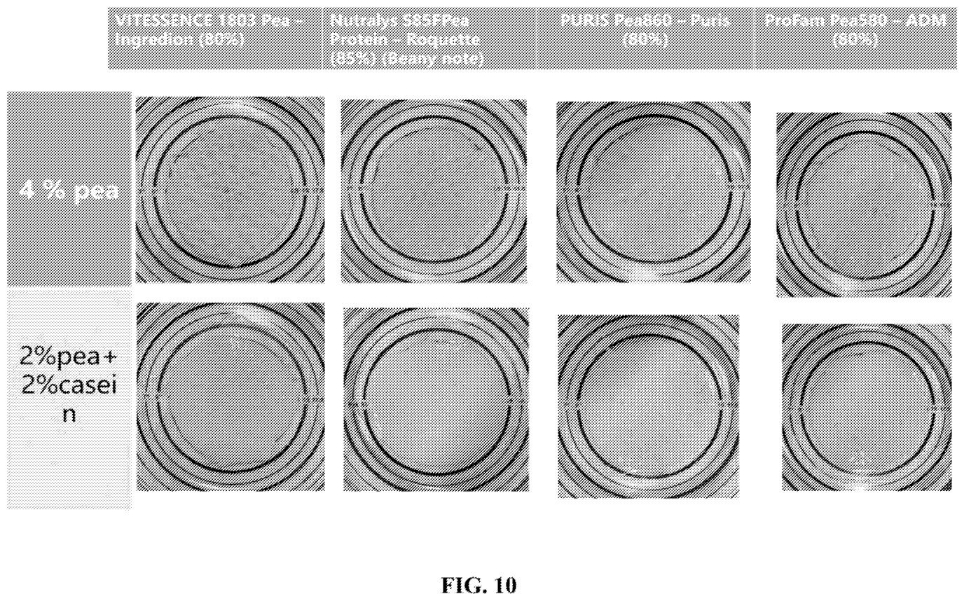

Pea proteins from different manufacturers were used with or without addition of casein to produce various cheese analog samples, which were then evaluated for cooking functionalities as described in Example 2 above. Different plant-based cheese analog samples were evaluated: 4% pea protein from various manufacturers with no casein added (top panel of FIG. 10), and 2% pea protein with 2% casein added (bottom panel of FIG. 10).

The results show that the addition of casein into pea protein-based cheese exhibited improved creaminess and provided a smoother mouthfeel, and reduced hardness of the cheese.

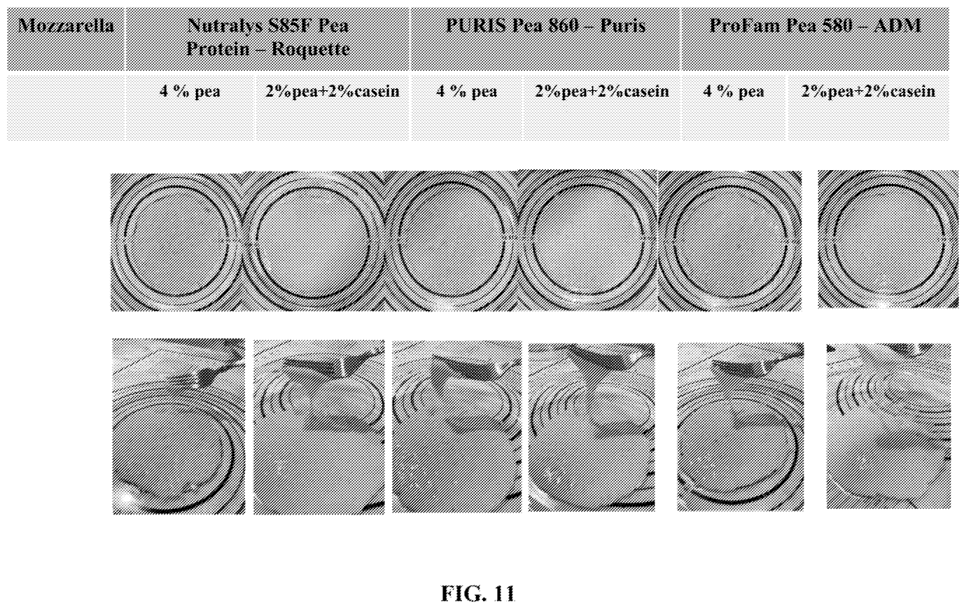

Similarly, pea proteins from different manufacturers were used with or without addition of casein to produce various cheese analog samples, which were then evaluated for cooking functionalities as described in Example 2 above. Different plant-based cheese analog samples were evaluated: 4% pea protein from various manufacturers with no casein added and 2% pea protein with 2% casein added (FIG. 11). The results show that the addition of casein into pea protein-based cheese surprisingly improved meltability and stretchability, improved creaminess and provided a smoother mouthfeel, and reduced hardness of the cheese.

### Example 6: Effects of Casein on Soy-Based Cheese

Commercial dairy cheese and soy-based cheese analog samples were analyzed for their formulations, cooking functionalities and sensory profiles. Dairy alternative cheese analog products containing plant-based protein ingredients such as, but not limited to soy, vegetable oils such as, but not limited to, soy, corn, and/or sunflower, commercially available gums and starches such as, but not limited to guar gum, pectin, potato and rice starches, GRAS ingredients such as, bot limited to, stabilizers, salts, flavor compounds and water.

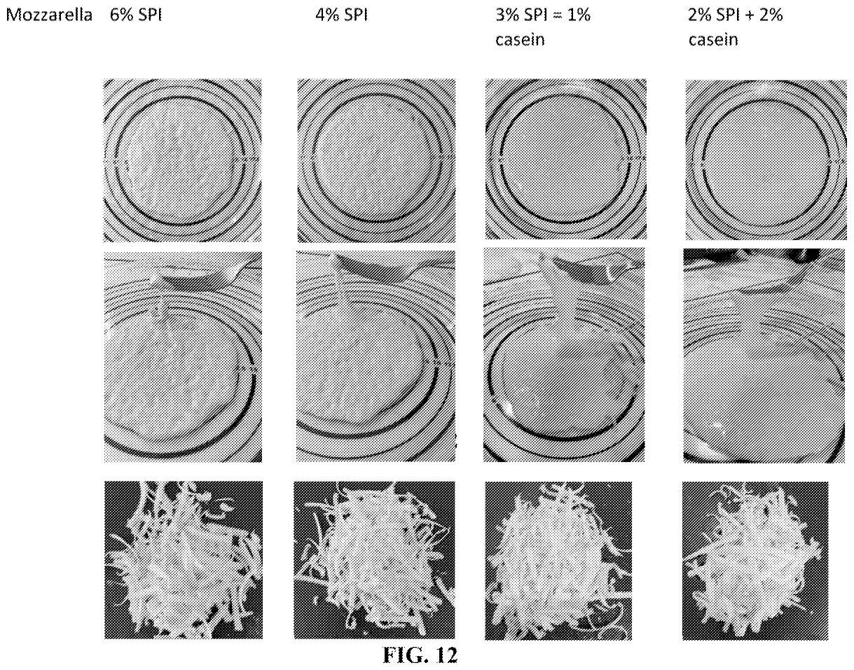

Soy-based cheese was seen to be beany, grainy and astringent, wherein soy proteins aggregated and demonstrated poor solubility. Soy-based cheese also had poor stretchability. When casein subunits αs1-casein, αs2-casein, and/or κ-casein were added to the soy-based cheese analog matrix, the resultant alternative cheese products demonstrated the following characteristics, in comparison to soy-based cheese: (1) improved meltability and stretchability; (2) improved creamy and smooth mouthfeel; (3) reduced hardness; and (4) higher whiteness color index (FIG. 12).

### Example 7: Baking Test of Different Plant-Based Cheese Products

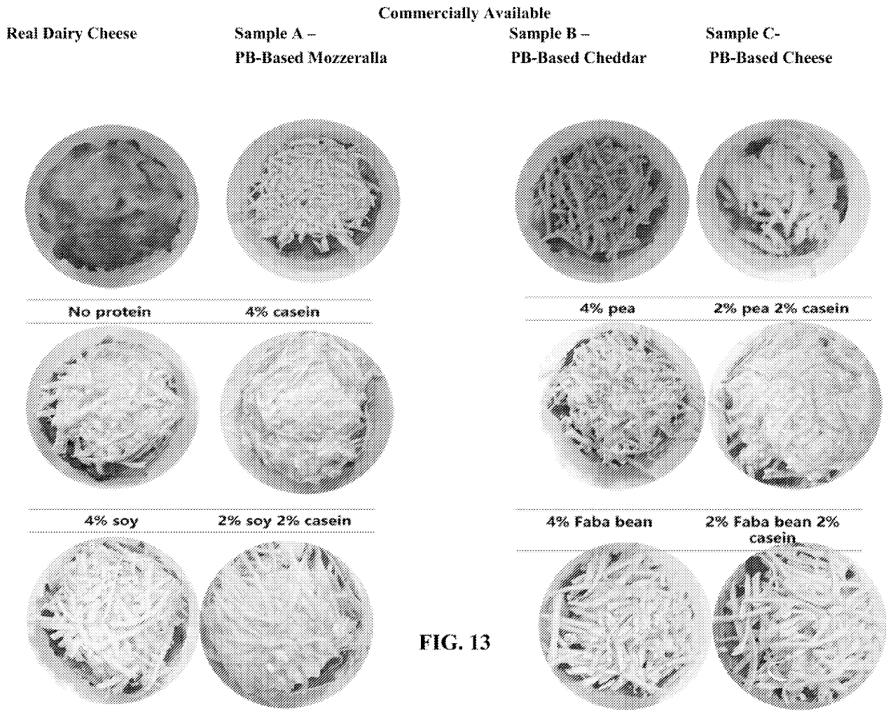

Three different commercially available plant-based Mozzarella-type or Cheddar-type cheese analog samples were evaluated in a baking test alongside a commercially available real dairy cheese sample, and experimental non-dairy plant-based cheese analog samples made from 4% soy (no casein), 4% casein (no plant protein), 2% soy and 2% casein, 4% pea (no casein), 2% pea and 2% casein, 4% Faba bean (no casein), and 2% Faba bean and 2% casein. In the experimental samples, the added casein was micellar casein. Samples in shredded form were placed in approximately equal amounts atop a base of a mini pizza and tomato sauce, and placed in a regular oven at 400° F. and baked for 5-minutes and/or until the samples gave the appearance of melting, blistering or browning. The results are shown in FIG. 13, showing that the soy protein-based and pea protein-based samples including casein demonstrate melting and browning properties more closely approximating the behavior of the real dairy cheese sample than any of the plant-based cheese analog samples lacking casein, with the possible exception of the faba bean protein-based samples. The data indicate that adding casein into a cheese analog made with soy protein, pea protein or faba bean protein, results in a dairy cheese alternative product with melting and browning properties more closely approximating the behavior of the real dairy cheese sample than any of the plant-based cheese analog samples lacking casein.

### Example 8: Dairy Alternative Yogurt with Casein Subunits

A blend of fermentation-derived casein subunits (a blend of αs1-casein and αs2-casein, β-casein, κ-casein, and para-κ-casein), pea protein, coconut oil, starch, gums, flavors and sugars/sweeteners, and plant-based cultures were added to the yogurt analog matrix. Various amounts of casein subunits and pea protein were assessed, e.g., 0.5%, 1%, or 2% of casein subunits, and 0%, 1%, 2%, 3%, 4%, or 5% of pea protein were mixed with coconut oil, corn starch, tapioca starch, pectin, flavors, and sugars/sweeteners. Table 2 below provides an exemplary plant-based yogurt analog formulation.

TABLE 2
Yogurt Analog Formula Example

| | |
|---|---|
| Water | 84.16% |
| Coconut Fat | 2.00% |
| Sugar | 6.00% |
| Pea Protein Isolate | 3-5% |
| Casein Subunits | 0-2% |
| Starch | 2-3% |
| Pectin | 0.06-1.2% |
| Total | 100.00% |

Each yogurt analog product was evaluated via various analytical tests, including pH, Rheological properties, Brix, Syneresis A, and sensory profile according to methods known in the art. For example, pH was measured by a pH meter. Rheological properties such as color were measured by a colorimeter and apparent viscosity measured by a Brookfield viscometer. Brix can be evaluated by a Brix meter. Syneresis is evaluated by a centrifugal acceleration test. Lastly, sensory profile is evaluated by a descriptive sensory test and/or a third party sensory panel test.

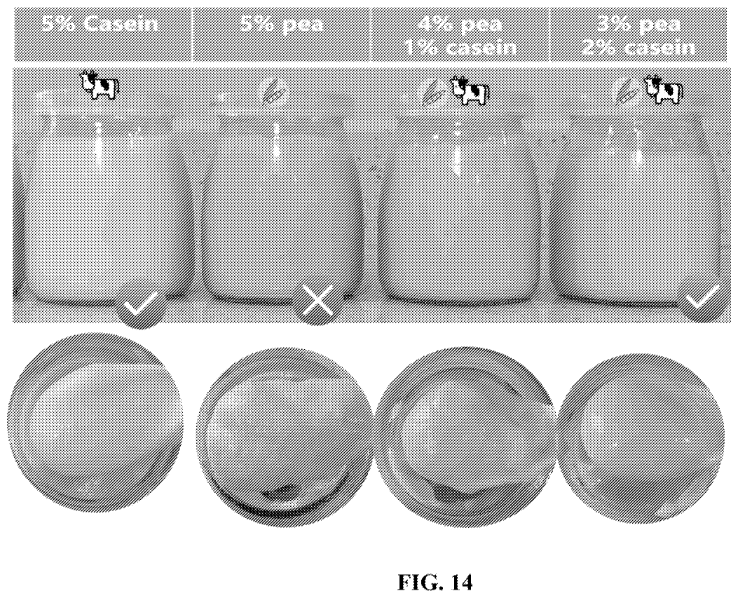

The addition of casein proteins into plant-based yogurt improved creaminess, provided a smoother mouthfeel, and reduced the beany quality, astringency, yellow color, and syneresis (FIG. 14). Additionally, the pea containing yogurt with casein added was more stable and milkier during shelf-life storage. Different pea yogurt analog samples were evaluated: 5% casein with no pea protein; 5% pea protein with no casein added; 4% pea protein with 1% casein added, and 3% pea protein with 2% casein added (exhibiting the best features).

### Example 9: Effects of Different Casein Subunits on Pea Yogurt

Different casein (α-casein, β-casein, and κ-casein) from Sigma-Aldrich Co., with various purity levels, were added to a pea-based yogurt analog matrix to produce various yogurt analog products, which were then evaluated as described in Example 2 above.

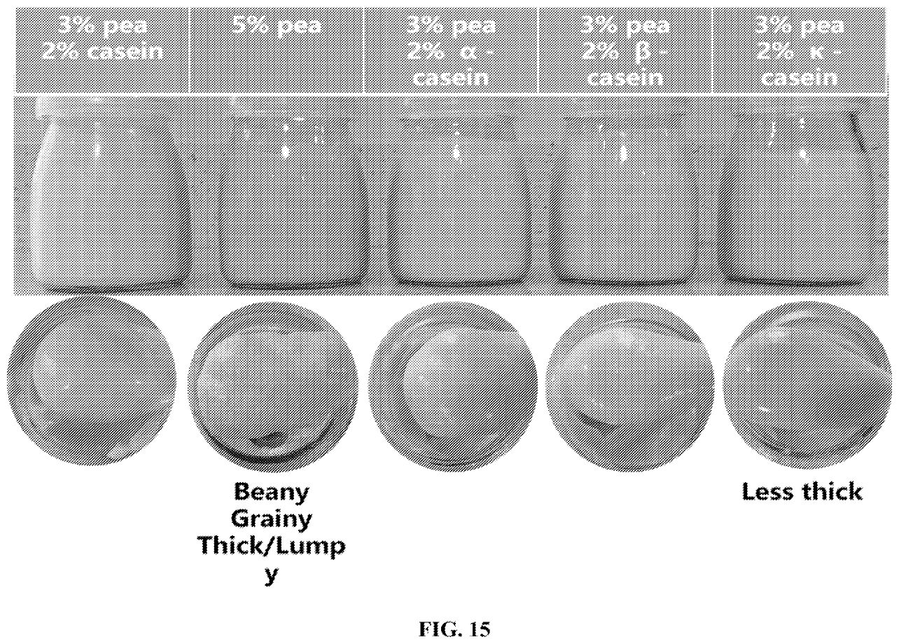

The addition of casein subunits into pea-based yogurt analog mixture improved creaminess and provided smoother mouthfeel, and reduced the beany quality, astringency, yellow color, and syneresis. Additionally, yogurt analog compositions with α-casein or β-casein had similar overall appearances. However, non-dairy yogurt with κ-casein had reduced thickness and was unable to cover the beany flavor originating with the pea protein (FIG. 15). Different pea-based yogurt analog samples were evaluated: 3% pea protein with 2% casein added; 5% pea protein with no casein added; 3% pea protein with 2% α-casein added; 3% pea protein with 2% β-casein added; and 3% pea protein with 2% κ-casein added.

Preliminary results indicate non-dairy yogurt analog products made with α-casein or β-casein provide a significant improvement in mouthfeel and gel strength than yogurt made with κ-casein.

### Example 10: Dairy Alternative Cheese Sauce with Casein Subunits

A blend of fermentation-derived casein subunits (a blend of αs1-casein and αs2-casein, β-casein, κ-casein, and para-κ-casein), pea proteins, coconut oil, starch, gum, salt, acid, and flavor agent(s) were used to produce cheese sauce. Various amounts of casein subunits and pea proteins were evaluated, e.g., 0.5%, 1%, or 2% of casein subunits, and 0%, 1%, 2%, 3%, 4%, 5%, or 6% of pea proteins were mixed with coconut oil, along with potato starch, corn starch, xanthan gum, salt, and citric acid. Cheese sauce products were formulated. Table 3 below shows an exemplary cheese sauce formulation.

TABLE 3
Cheese Sauce Formula

| | | | |
|---|---|---|---|
| Water | 63.98% | Casein Subunits | 1.00-2.00% |
| Coconut Fat | 20.00% | Salt | 1.00% |
| Creamy Starch | 1.00% | Flavor | 0.50% |
| Tapioca Flour | 10.00% | Potassium Sorbate | 0.10% |
| Pea Protein | 2.00-3.00% | Citric Acid | 0.30% |
| Xanthan Gum, | 0.10% | Color - Carotene | 0.02 |
| locus bean gum | | | |

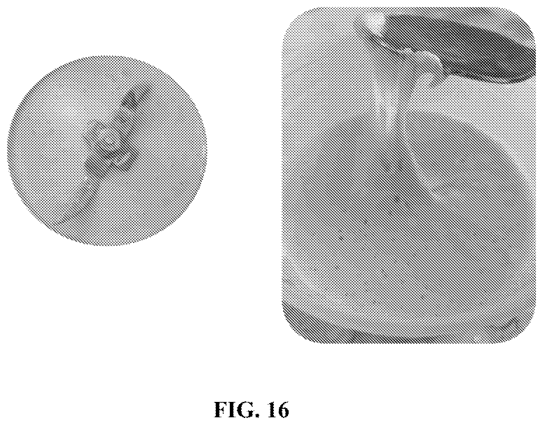

FIG. 16 shows the cheese sauce exhibited improved creaminess and provided a smoother mouthfeel, and reduced hardness of the cheese sauce.

### Example 11: Impact of Casein Subunits and Combinations Thereof in Plant-Based Cheese

Several analytical methods were used to investigate impact of casein subunits and combinations thereof in plant-based cheese analogs, including, but not limited to, texture analyzer/analysis (compression, single punch test, or shred tension test), microwave disk melt, microwave fork stretch test, oven disk melt, oven fork stretch test, and shred quality.

In general, to prepare cheese and cheese analog samples for analysis, a silicone cylinder mold was used to form cheese cylinders about 25 mm diameter. Cylinders were then popped out and hand-held wire cheese cutter was used to scrape off any case hardening or oil coating on the cheese. Full cylinders of cheese were used for texture analysis with flat edge down, while disks were cut out of the cheese cylinders with 5 mm thickness egg cutter for microwave and oven disk melt tests. Extra pieces of cheese were shredded along with extra cylinders for texture analysis tension test. The quality of these shreds was then observed and recorded. The analytical methods used in this study are described below in detail.

Texture Analyzer (TA) Single Punch Test: To prepare cheese and cheese analog samples for this test, cylinders were first removed from the silicone tray. A wire cheese cutter was used to shave off any case hardening or oil out that settled at the top of the cheese. Next, the top of the sample was cut to create a flat surface for texture analysis. The cylinder was placed right side up, so that flat bottom of the sample was in contact with the TA platform. The samples were held in refrigerator until time of test.

TA-18, ball probe and raised testing platform were used for the test. The Texture Analyzer was calibrated with 2 kg weight. Texture Analyzer was set up based on the following settings: Sequence: Repeat until count; Pre-test speed: 1 mm/sec; Test speed: 2 mm/sec; Post-test speed: 10 mm/sec; Target mode: Distance, 5 mm; Count: 2; Trigger type: Force, 5 g. Cylinders were removed from the platform following test and cleaned off probe from any debris.

Microwave Melt Test: This test measures melt % spread of samples after microwave heating. One disk of 5 mm thick and about 25 mm diameter was placed in the center of a glass petri dish. A sample was then placed on top of a piece of bullseye paper and a picture was taken of the sample. The diameter of the sample area was measured at 3 different cross sections with a digital caliper. After that, the sample was microwaved for 8 seconds. The sample was then taken out of the microwave and another picture was taken of the on top of the bullseye paper. The diameter of the sample area was again measured at 3 different cross sections with a digital caliper after the dish cooled down. With the measurements, the melt % spread is calculated using the following formula:

MeltedAvgDiameter−RawAvgDiameter)/RawAvgDiameter)*100.

Oven Melt Test: This test measures melt % spread of cheese samples after oven heating. A conduction oven was preheated to 400-450 F. One disk of 5 mm thick and 39.5 mm diameter was placed in the center of a glass petri dish. A sample was then placed on top of a piece of bullseye paper and a picture was taken of the sample. The diameter of the sample area was measured at 3 different cross sections with a digital caliper. After that, the sample was covered with the petri dish top and baked for 5 min in the oven. The sample was then taken out of the oven and another picture was taken of the sample on top of the bullseye paper. The diameter of the sample area was again measured at 3 different cross sections with a digital caliper after the dish cooled down. With the measurements, the melt % spread is calculated using the following formula:

((MeltedAvgDiameter−RawAvgDiameter/RawAvgDiameter)*100.

Fork Stretch Test: This test was done to both microwave heated and oven heated cheese samples. A petri dish was set up under light box with a ruler and a tripod. A fork was slidden under the center of molten cheese sample at a 45-70 degree angle, then pulled up slowly and consistently. A video was taken to capture the peak height of stretch and the profile of the stretch was observed.

Texture Analyzer (TA) Stretch Test: Before the test, a convection oven was preheated to 400 F. Texture Analyzer was set up based on the following settings: Sequence: Return to Start; Tension, Test Speed: 10.0 mm/sec; Post-Test Speed: 20.0 mm/sec; Target mode: Distance, 227 mm; Trigger type: Button Trigger. 15-20 g shredded cheese was added to the test well. The cheese was evenly distributed around the metal hook. The metal ring was added on top of the cheese to hold down the edges.

During the test, a cheese sample was heated for 10 min in the oven, and then removed from the oven and TA test was initiated within 15 seconds. When the sample completely separated from the base, the space bar was clicked to mark an “Event”. After that, the test well, lifting plate and ring were cleaned with a mild detergent and soft brush between tests.

To process the data, Tension TA Cheese Stretch Macro was used to analyze the Peak Force, Work required to pull, and Distance to Failure of a sample.

To determine the impact of casein subunits and casein subunit combinations in plant-based cheese analogs, the following casein subunit formulations were used: Negative Control (4% pea protein); individual subunits (2% α-, β-, or κ-casein); combinations of 2 subunits (2% α- & β-casein; 2% α- & κ-casein; and 2% β- & κ-casein); combinations of all 3 subunits (˜2% total of α-, β-, and κ-casein). Table 4 below lists the various casein fraction mixtures that were used in this study.

TABLE 4

| Casein Fraction Mixture | α-casein (%) | β-casein (%) | κ-casein (%) |
|---|---|---|---|
| Singular Fraction | 2 | 0 | 0 |
| | 0 | 2 | 0 |
| | 0 | 0 | 2 |
| 2 Fraction Combination | 1 | 1 | 0 |
| | 1 | 0 | 1 |
| | 0 | 1 | 1 |
| 3 Fraction Combination | 0.667 | 0.667 | 0.667 |
| | 1.33 | 0.33 | 0.33 |
| | 0.33 | 1.33 | 0.33 |
| | 0.33 | 0.33 | 1.33 |

To prepare cheese samples, all solids were mixed to ensure a homogenous combination of powders. Any larger pieces were crushed to facilitate homogenous combination. Melted oil and water were added to a RVA container, followed by the addition of solids. A small spatula was used to stir the mixtures. Afterwards, a mixing paddle was added and clicked into RVA setup. The RVA was set up based on the following procedure settings: 1 minute at 37° C., 100 RPM; 3 min at 37° C., 870 RPM; 5 min at 70° C., 500 RPM; 2 min at 90° C., 500 RPM; and end at 80° C. The samples were refrigerated at least 48 hrs before tasting/testing.

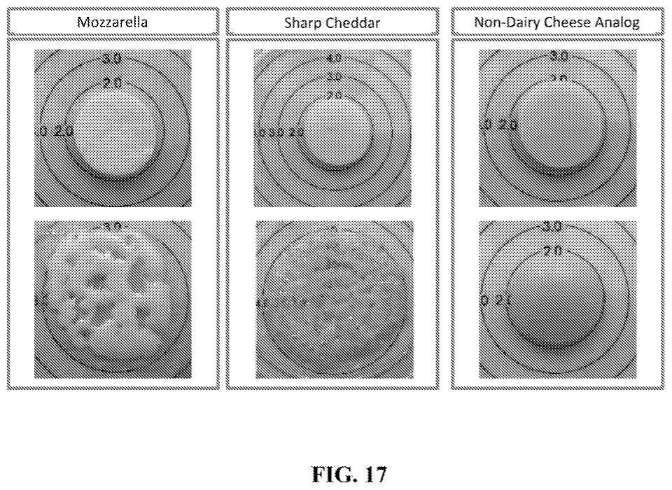

For oven melt test, mozzarella, sharp cheddar, and vegan block cheese from a consumer brand were used as controls. As shown in FIG. 17, fresh mozzarella spread out in a heterogeneous way as cheese solids were seen to have coagulated together whereas oil separated out. Cheddar spread out, forming a thin film of cheese with browning on edges. Vegan block cheese did not spread out during oven melt with coating forming on outside and pasty inside.

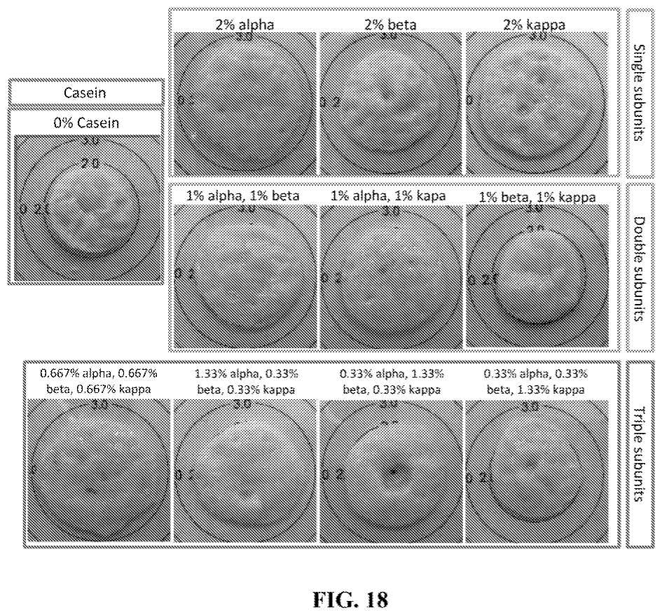

The qualitative data of oven melt tests performed on various plant-based cheese analog products that contain single, double or triple casein subunits are illustrated in FIG. 18. Control cheese, which contains 0% casein, was seen to be puffed up in the oven and shriveled after bake. Also, little melt spread was observed. It was gooey inside with dried up outer coating. Cheese sample containing 2% α-casein subunit was seen to have wide melt spread. It had bubbles throughout, but cheese edge of spread was not uniform. Cheese sample containing 2% β-casein subunit was seen to be puffed up a bit in the oven and spread out some. It kept pasty and cohesive texture. Cheese sample containing 2% κ-casein subunit was seen to have wide melt spread with bubbles throughout. It had more uniform edges.

Overall, the qualitative data of oven melt tests suggest that α-casein subunit dominated the oven melt profile, which included bubbly melt with oily surface, like dairy cheese. κ-casein subunit individually and in combination with α-casein subunit had similar melt behavior as α-casein subunit. However, κ-casein subunit combined with β-casein subunit showed melt behavior similar to control cheese. β-casein subunit samples puffed up with similar profile as control cheese, which included stuck to top of the dish and crater in the middle.

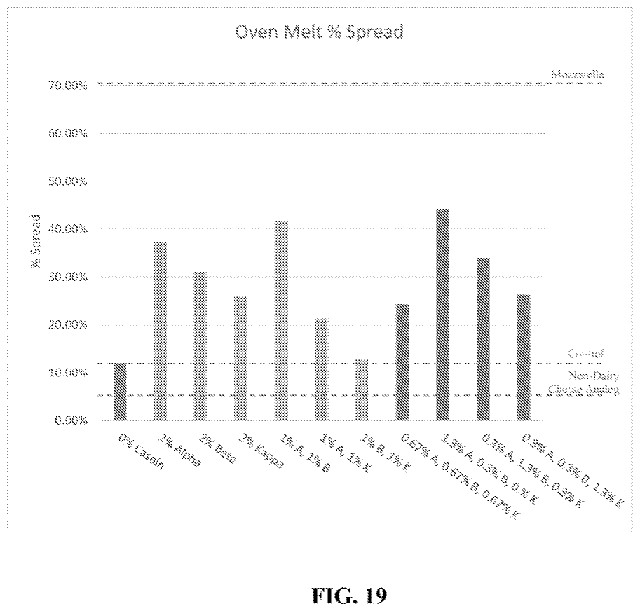

The quantitative data (% spread) of oven melt tests performed on various plant-based cheese analog products that contain single, double or triple casein subunits are illustrated in FIG. 19. It is shown that addition of casein subunits improved the oven melt % spread. Cheese samples containing 1% β-casein and 1% κ-casein had the lowest spread, most comparable to 0% casein. All other casein subunit combinations had much larger melt % spreads. Cheese samples containing 2% α-casein, 1% α-/1% β-casein, 1.3% α-/0.3%13-10.3% κ-casein subunits exhibited best oven melt spread. The results suggest that α-casein dominated oven melt % spread.

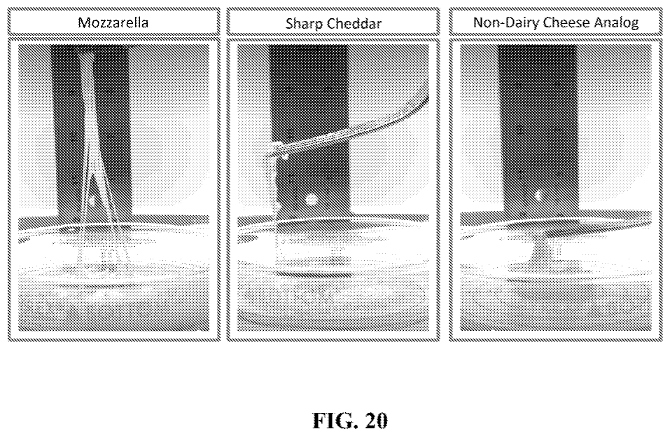

For oven stretch test, mozzarella, sharp cheddar, and the vegan block cheese analog from a consumer brand were used as controls. As shown in FIG. 20, mozzarella stretched with strong tension, and became stringy from a tented base. Cheddar spread very thin across plate, and there was not much stretch due to melt profile. Vegan cheese became pasty and hardly stretched up, and was seen to have outer coating on bubble of cheese. Also, for the control vegan cheese analog, no tension was felt, and the sample fell off fork.

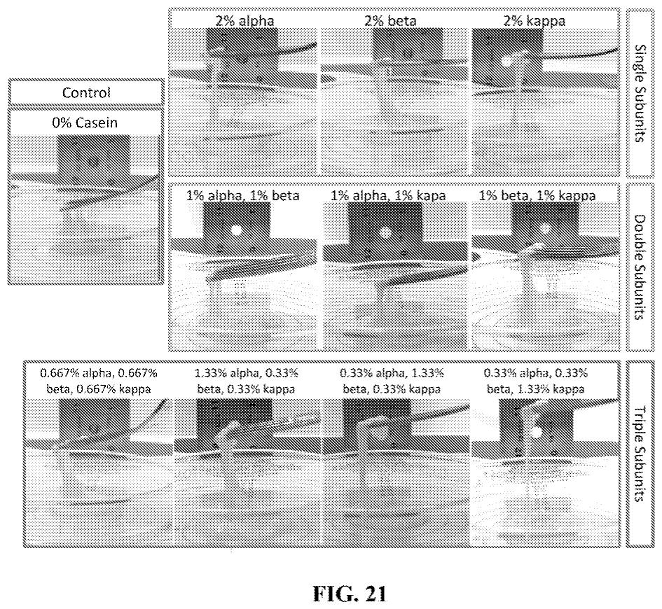

The qualitative data of oven stretch tests performed on various plant-based cheese analog products that contain single, double or triple casein subunits are illustrated in FIG. 21. Control cheese analog, which contains 0% casein, was seen to have a dried-out coating with melty inside. It had a pasty stretch, and stretch did not have any tension or height based on cheese globs falling off fork. However, with the addition of casein subunit(s), the quality of the stretch improved with a more consistent and broad pull. The cheese analog sample containing 2% α-casein subunit was seen to have a stringy pull. The cheese analog stretched at one point and thinned out with pull up. The cheese analog sample containing 2% β-casein subunit was seen to have a wider stretch and the cheese pulled up across the disk. The cheese analog sample containing 2% κ-casein subunit was seen to be pulled up with a tent like pull at the base, and thinned out with height.

Overall, the qualitative data of oven stretch tests suggest that α-casein subunit contributed stringy and tall pull. The stretch had less strong tension and was more pasty/stringy. Double fraction combinations with α-casein subunit did not improve height of the pull. β-casein subunit contributed to wider pull. When combined with κ-casein subunit or with α- and κ-casein subunits, β-casein subunit resulted in good height and pull. κ-casein subunit contributed to strong, stringy pull with tent like bottom. Furthermore, the results show that triple subunit combinations were better at uneven concentrations as 1:1:1 (equal amount of α-, β-, and κ-casein subunits) had a lower stretch.

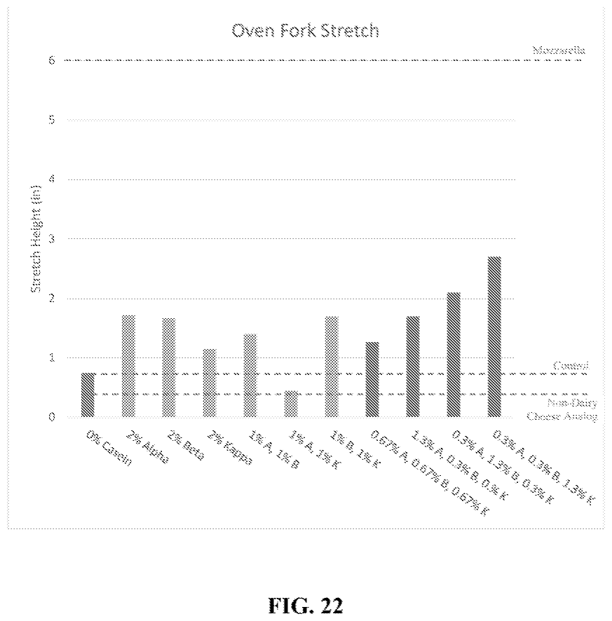

The quantitative data (height) of oven stretch tests performed on various plant-based cheese analog products that contain single, double or triple casein subunits are illustrated in FIG. 22. It is shown that most combinations of casein subunits improved the fork stretch height of cheese analog products melted in the oven, while 1% α- and 1% κ-casein combination had reduced stretch height. The highest stretch was observed with combination 0.3% α-/0.3% β-/1.3% κ-casein subunits. The results also show that 2% α-casein subunit or 2% β-casein subunit had a higher stretch than 2% κ-casein subunit, and that in combination with other subunits, α-casein subunit did not positively influence the stretch as much, whereas κ-casein subunit had a similar stretch profile to real dairy mozzarella (i.e., tent-like pull from plate), and positively impacted the stretch height when combined with other subunits.

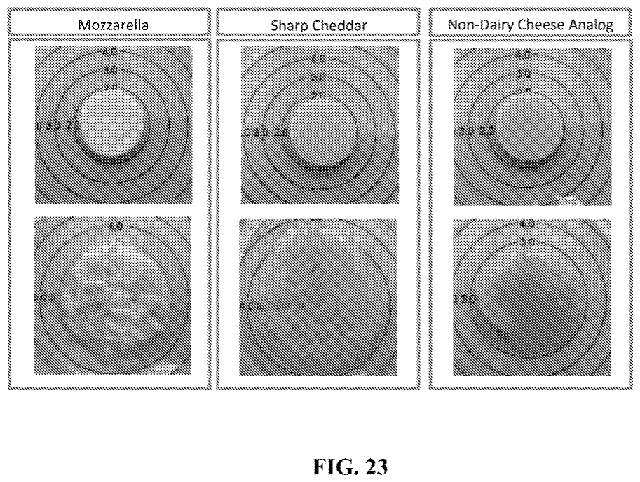

For the microwave melt test, real dairy mozzarella, real dairy sharp cheddar, and a vegan, non-dairy block cheese analog from a consumer brand were used as controls. As shown in FIG. 23, the real mozzarella cheese spread out and released liquid (water/oil) as it melted. The melt was heterogeneous, but wide. The real cheddar cheese spread out in a more homogenous manner and formed an oily coating on the cheese. The non-dairy cheese analog spread out more consistently and maintained a pasty, homogenous texture.

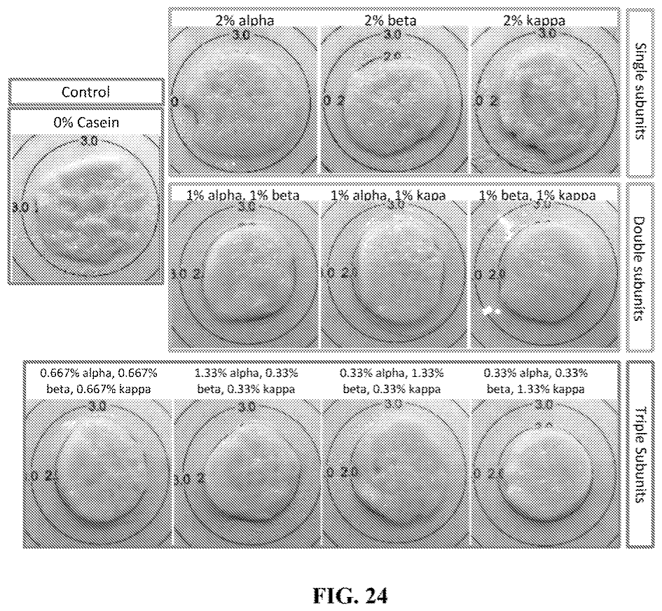

The qualitative data of microwave melt tests performed on various plant-based cheese analog products that contain single, double or triple casein subunits are illustrated in FIG. 24. There were some differences between samples, but impact with casein was small in microwave as compared to control formulation. In particular, the control cheese analog, which contains 0% casein, was seen to have some spread with small bubbles. The control cheese analog maintained a pasty appearance. The c analog sample containing 2% α-casein subunit was seen to have bubbles within, and oil out around the cheese product disk. The cheese analog sample containing 2% β-casein subunit was seen to have bubbles throughout. The sample had showed some oily coating and uneven spread. The cheese analog sample containing 2% κ-casein subunit was seen to have bubbles throughout. The sample had uneven spread and pasty/oily coating.

Overall, the qualitative data of microwave melt tests suggest that control cheese had comparatively wide melt spread, similar to samples with casein additions. Cheese analog samples containing α-casein subunit had wider spread with oily surface and bumpy melt edge. Cheese analog samples containing β-casein subunit had more consistent edge and less visible melt impact. Cheese analog samples containing κ-casein subunit had inconsistent spread and bumpy edge. In addition, cheese analog samples containing combinations of 2 or 3 casein subunits/fractions showed less spread and similar melt profiles as those containing single subunits/fractions.

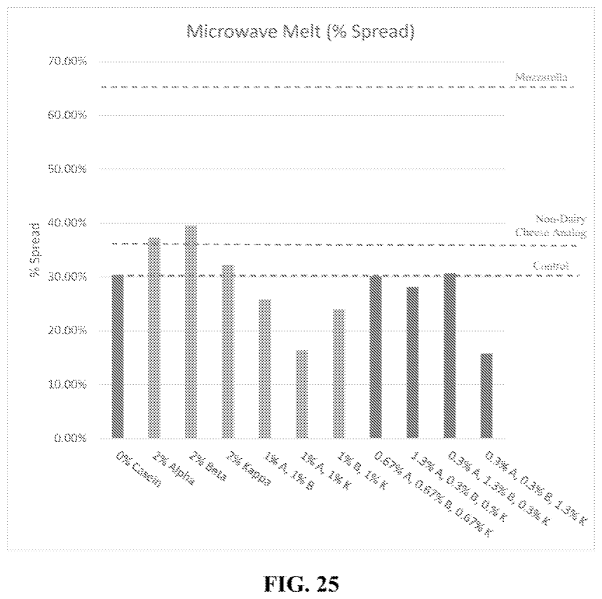

The quantitative data (% spread) of microwave melt tests performed on various plant-based cheese analog products that contain single, double or triple casein subunits are illustrated in FIG. 25. It is shown that in general, the control cheese analog and cheeses analogs containing casein subunits performed similarly during microwave melt. In particular, melt % spread was improved with 2% α- or 2% β-casein samples. Some combinations of casein subunits/fractions slightly improved melt % spread, while other combinations decreased the melt % spread as compared to the control cheese. Overall, the results do not suggest that any one specific casein subunit dominates microwave melt behavior.

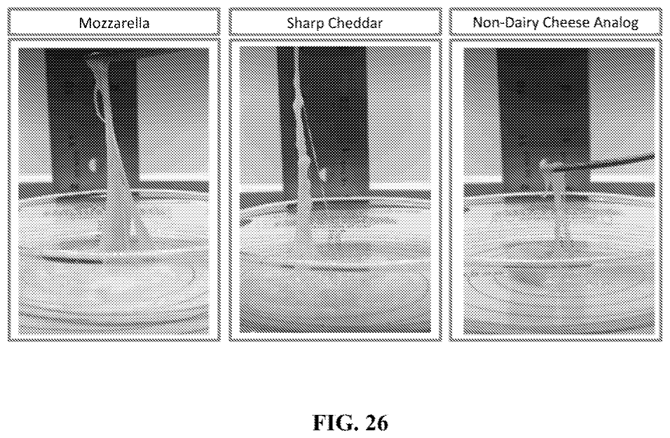

For microwave stretch test, real dairy mozzarella, real dairy sharp cheddar, and the vegan, non-dairy block cheese analog from a consumer brand were used as controls. As shown in FIG. 26, the mozzarella pulled up from the plate with a strong, consistent tension. In particular, mozzarella stretched out of the camera range with a consistent pull that incorporated the whole piece of cheese on the plate. Cheddar stretch was less consistent and stringy. Vegan block cheese pulled up from one part of the cheese with a stringy, pasty texture. It had much less height on fork stretch. Compared to oven stretch, vegan clock cheese in the microwave was much less pasty, but had better stretch and consistency. Both real mozzarella and real cheddar had higher stretch than the vegan block cheese analog.

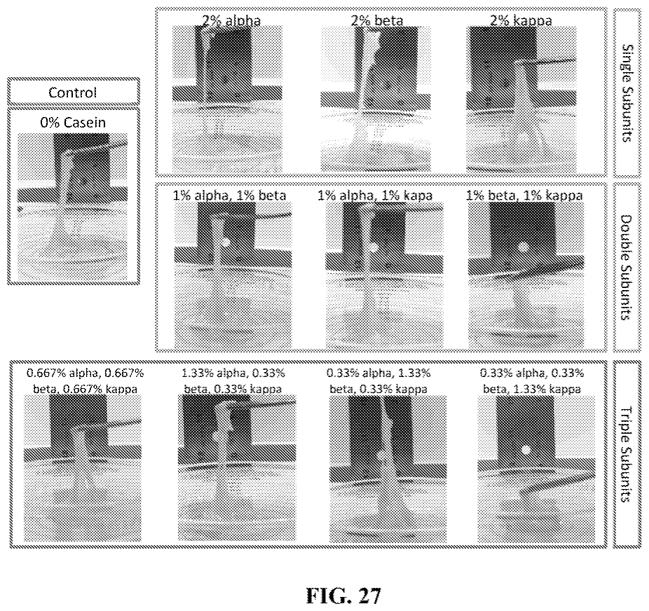

The qualitative data of microwave stretch tests performed on various plant-based cheese analog products that contain single, double or triple casein subunits are illustrated in FIG. 27. Control cheese had tall pull and tension. Cheese sample containing 2% α-casein subunit was seen to have a stringy and tall stretch. Cheese sample containing 2% β-casein subunit was seen to have a wider stretch, but the stretch became stringy at the top. Cheese sample containing 2% κ-casein subunit was seen to have a wide stretch across the diameter of cheese. It had a tent-like pull. No breakage occurred while cheese was removed from the dish.

Overall, the qualitative data of microwave stretch tests show that control cheese had inconsistent but high stretch. When cheese dried out in microwave, there was minimal stretch. The sample containing α-casein subunit had stringy stretch. When further combined with β- or κ-casein subunit, the sample had strong and high stretch. Samples containing β-casein subunit alone or combination of β-casein subunit and other casein subunit had stringy, tall stretch. The sample containing κ-casein subunit had strong, tent like pull, but less tall stretch compared to control sample containing α- or β-casein subunit. Samples containing combinations of major κ-casein subunit concentrations had negative impact on stretch height (see, e.g., the sample containing 0.33% α-, 0.33% β-, and 1.33% κ-casein subunits in FIG. 27).

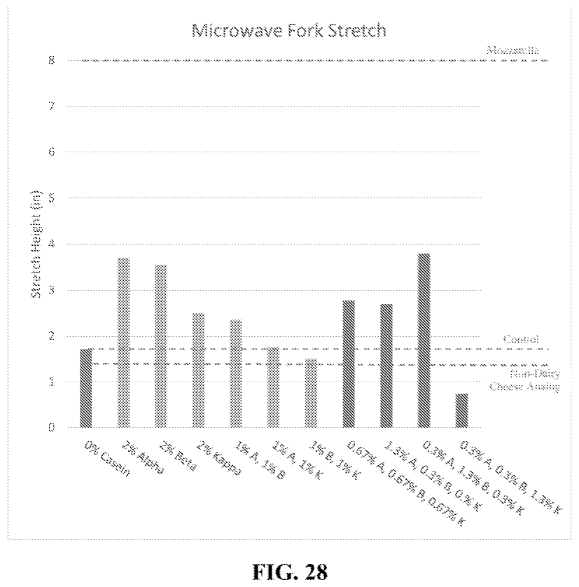

The quantitative data (height) of microwave stretch tests performed on various plant-based cheese analog products that contain single, double or triple casein subunits are illustrated in FIG. 28. It is shown that microwave stretch increased with most combinations of casein subunits. For example, α- and/or β-casein subunits positively impacted microwave stretch, among which the sample containing 2% α-casein subunit, the sample containing 2% β-casein subunit, and the sample containing 0.3% α-/1.3% β-10.3% κ-casein subunits had the best microwave stretch. In the other hand, κ-casein subunit individually had a lesser positive impact on microwave stretch height. As seen in FIG. 28, the sample containing 1% β-11% κ-casein subunits or the sample containing 0.3% α-/0.3% β-11.3% κ-casein subunits decreased fork stretch height. The results suggest that higher levels of κ-casein subunits decrease the height of microwave melt stretch.

Overall, the oven and microwave melt and stretch tests show that casein subunits improve the melt and stretch of plant-based cheese analogs. In particular, α-casein subunit dominates/positively impacts cheese analog stretch and melt profile in the oven. β-casein subunit individually also had positive impacts on oven stretch, while κ-casein subunit positively impacted stretch in combination of 1% κ-/1% β-casein subunits or triple fraction combination. For oven melt, combination of α- and κ-casein subunits had positive impact, while κ- and β-casein subunit combination negatively impacted melt % spread. Combination of α- and β-casein subunits had more positive impact in microwave stretch than κ-casein subunit, while microwave melt was not suggestive of typical cheese melting behavior.

Melt % spread as well as stretch height (quantitative analysis) should be combined with qualitative observations for overall understanding of the impact of casein subunits on plant-based cheese analogs. The results suggest that α-casein subunit dominates melt and stretch in the oven with wide % spread and tall, stringy stretch, and that κ-casein subunit is representative of the strong pull up of dairy cheese as it improves the profile of the stretch and pulls from a wide part of the cheese rather than one string.

### Example 12: Quantification of Plant-Based Cheese Analog Compositions

Constitutive models for certain materials that exhibit viscoelastic behavior can be used to quantify that behavior. These types of models are used to accurately represent the viscoelastic behavior of materials including polymers. Such models quantitatively relate the state of the stress in the material to the deformation history, and are useful in a structure-texture engineering context. Certain equations define the firmness, springiness, and rubberiness of semi-soft food gels such as cheeses that exhibit broad power-law stress relaxation over a wide range of timescales (Faber, et al., Food Hydrocolloids, 62, 311-324; 2017). These equations contain a fractional exponent to quantify the frequency and temporal response, and a scale factor or “quasi-property” indicating the magnitude of stress in the material. These two factors form a constitutive element, known as the “springpot” or Scott Blair element, which can accurately capture the viscoelastic properties of food gels including semi-hard cheeses, or non-dairy cheese analogs.

Using the framework of fractional calculus, the linear viscoelastic properties of full-fat, low-fat, and zero-fat, semi-hard cheeses have been quantified over a range of temperatures and water/protein ratios (Faber, et al., Food Hydrocolloids, 62, 325-339; 2017). These fractional constitutive models correctly predicted the time-dependence and interrelation of the firmness, springiness, and rubberiness of these emulsion-filled hydrocolloidal gels. The equations for the firmness, springiness, and rubberiness also correctly predicted the effect of changing the magnitude or timescale of the stress loading on the material even in the case of irreversible flow events, when cheese progressively transitioned from a solid to a liquid.

Thus, constitutive models can be comparably applied to the plant-based cheese analog described above and herein, to quantify the linear viscoelastic properties of the plant-based cheeses as also described above and herein. Equations are formulated that quantify the firmness, springiness, and rubberiness of the plant-based cheese analogs that contain various casein subunits, and display the melting and stretching features as described herein. Such equations will allow for extrapolation of a firmness measurement to indicating how the cheese analogs behave when subjected to prolonged creep loading in practical use.

Additionally, strain at the departure from linear viscoelasticity (i.e., strain-to-break) is an useful metric for quantifying brittle-like behavior (Nelson et al., J. Rheol. 62, 357-369; 2018). A criterion is set to identify whether a cheese or cheese analog is brittle or ductile (e.g., ranking the cheese in terms of the brittle-like behavior), and a “brittleness index” determined and compared to rheological properties that can be measured in shear experiments.

The individual disclosure of each and every publication, patent, and patent application cited herein is hereby incorporated by reference in its entirety. In the event of any conflict in meaning between a term used herein and a term contained in an incorporated reference, the term as used herein shall control.

1. A dairy alternative cheese analog composition, comprising:
(a) about 0.1% to about 25% by weight of at least one casein subunit;
(b) about 1% to about 28% by weight of at least one plant protein;
(c) at least one non-dairy fat; and
(d) at least one stabilizer component.

2. The dairy alternative cheese analog composition of claim 1, wherein the at least one casein subunit comprises α-casein, αs1-casein, αs2-casein, β-casein, κ-casein, para-κ-casein or a combination thereof.

3. The dairy alternative cheese analog composition of claim 1, wherein the at least one non-dairy fat is in an amount of about 15% to about 40% by weight of the composition.

4. The dairy alternative cheese analog composition of claim 3, wherein the at least one non-dairy fat comprises soybean oil, corn oil, coconut oil, canola oil, sunflower oil, coconut cream, palm oil, avocado oil, coconut butter, olive oil, hazelnut oil, sesame oil, walnut oil, almond oil, cocoa butter, grapeseed oil, hemp oil, safflower seed oil, vegetable oil, high oleic fatty acid oil, and/or a combination thereof.

5. The dairy alternative cheese analog composition of claim 1, wherein the at least one stabilizer component comprises at least one starch, at least one gum, at least one pectin, and/or a combination thereof.

6. The dairy alternative cheese analog composition of claim 5, wherein the at least one starch is selected from the group consisting of potato starch, corn starch, tapioca starch, rice starch, plantain starch, and/or a combination thereof, and wherein the at least one gum is selected from the group consisting of xanthan gum, locus bean gum, guar gum, agar, konjac gum, gum acacia, gum arabic and a combination thereof.

7. The dairy alternative cheese analog composition of claim 1, further comprising at least one organic or inorganic acid, and/or at least one emulsifying salt.

8. The dairy alternative cheese analog composition of claim 7, wherein the at least one organic or inorganic acid comprises citric acid, lactic acid, malic acid, tartaric acid, a phosphoric acid, and/or a combination thereof, and wherein the at least one emulsifying salt is selected from the group consisting of sodium citrate, trisodium citrate, tetrasodium pyrophosphate, sodium tripolyphosphate, sodium hexametaphosphate, disodium orthophosphate, and/or a combination thereof.

9. The dairy alternative cheese analog composition of claim 1, wherein the composition has improved stretchability, meltability and/or mouthfeel compared to a plant-based dairy-free cheese analog product not comprising casein or at least one casein subunit.

10. The dairy alternative cheese analog composition of claim 1, wherein the composition comprises about 0.3% to about 2% by weight of α-casein.

11. The dairy alternative cheese analog composition of claim 10, further comprising about 0.3% to about 2% by weight of β-casein.

12. The dairy alternative cheese analog composition of claim 11, further comprising about 0.3% to about 2% by weight of κ-casein.

13. The dairy alternative cheese analog composition of claim 1, further comprising at least one plant protein.

14. The dairy alternative cheese analog composition of claim 13, wherein the at least one plant protein comprises one or more proteins derived from oat, rice, corn, quinoa, wheat, buckwheat, soy, pea, faba (fava) bean, canola (rapeseed), lupin, lentil, chickpea, peanuts, almond, cashew, macadamia, hazelnut, walnut, mushrooms, mushroom mycelium, duckweed, rapeseed (canola), and/or algae.

15. A dairy alternative yogurt analog composition, comprising:
(a) about 0.1% to about 25% by weight of at least one casein subunit;
(b) about 1% to about 28% by weight of at least one plant protein;
(c) at least one non-dairy fat;
(d) at least one stabilizer component; and
(e) a yogurt culture.

16. The dairy alternative yogurt analog composition of claim 15, wherein the at least one casein subunit comprises α-casein, αs1-casein, αs2-casein, β-casein, κ-casein, para-κ-casein and/or a combination thereof.

17. The dairy alternative yogurt analog composition of claim 15, wherein the at least one non-dairy fat comprises at least one plant-based fat in an amount of about 1% to about 20% by weight of the composition.

18-20. (canceled)

21. The dairy alternative yogurt analog composition of claim 15, further comprising at least one organic and/or inorganic acid, at least one emulsifying salt, and/or at least one sugar and/or sweetener.

22. (canceled)

23. The dairy alternative yogurt analog composition of claim 21, wherein the at least one emulsifying salt is selected from the group consisting of sodium citrate, trisodium citrate, tetrasodium pyrophosphate, sodium tripolyphosphate, sodium hexametaphosphate, disodium orthophosphate, and/or a combination thereof.

24. The dairy alternative yogurt analog composition of claim 21, wherein the at least one sugar or sweetener comprises a monosaccharide, a disaccharide, and/or a combination thereof.

25. The dairy alternative yogurt analog composition of claim 21, wherein the at least one sugar and/or sweetener comprises a non-caloric sugar and/or sweetener, an artificial sugar and/or sweetener, a natural sugar and/or sweetener, a plant-based sugar and/or sweetener, and/or a combination thereof.

26-29. (canceled)

30. The dairy alternative cheese analog composition of claim 1, further comprising at least one antimicrobial component.

31. The dairy alternative cheese analog composition of claim 30, wherein the at least one antimicrobial component comprises nisin, Lactobacillus microorganisms, or potassium sorbate.

32-33. (canceled)

34. A dairy alternative food composition, comprising:
(a) about 0.1% to about 25% by weight of at least one casein subunit;
(b) about 1% to about 28% by weight of at least one plant protein;
(c) at least one plant-based or non-animal fat;
(d) at least one stabilizer component; and
(e) at least one sugar and/or sweetener.

35-47. (canceled)
